(19) United States
(12) Patent Application Publication
(10) Pub. No.: US 2025/0366496 A1
(43) Pub. Date: Dec. 4, 2025

(54) Feed for an Aquatic Animal and Method of Feeding an Aquatic Animal

(71) Applicants: Alejandro Markovits Rojas, Santiago (CL); Steven Harting Eckman, Santiago (CL)

(72) Inventors: Alejandro Markovits Rojas, Santiago (CL); Steven Harting Eckman, Santiago (CL)

(21) Appl. No.: 18/679,733

(22) Filed: May 31, 2024

(51) Int. Cl. A23K 50/80; A23K 20/158; A23K 20/22; A23K 40/10

(52) U.S. Cl. CPC A23K 50/80; A23K 20/158; A23K 20/22; A23K 40/10

(57) ABSTRACT

A method of feeding an aquatic animal in a hatchery or farm of the aquatic animal with a feed including one or more alkali metal salts of fatty acids. A feed for a fish or a crustacean including one or more alkali metal salts of fatty acids, the use of the feed of one or more alkali metal salts of fatty acids for increasing biomass production efficiency, survival rate and/or omega 3 fatty acid content of a crustacean or fish held in a hatchery or farm. A method for producing a processed product from a fish or crustacean fed with the feed, and a method for producing a feed for feeding a fish or crustacean.

### BACKGROUND OF THE INVENTION

### Field of the Invention

The present invention relates to a method of feeding an aquatic animal in a hatchery or farm of the aquatic animal with a feed comprising one or more alkali metal salts of fatty acids. The present invention also relates to a feed for a fish or a crustacean comprising one or more alkali metal salts of fatty acids, the use of the feed of one or more alkali metal salts of fatty acids for increasing biomass production efficiency, survival rate and/or omega 3 fatty acid content of a crustacean or fish held in a hatchery or farm, a method for producing a processed product from a fish or crustacean fed with the feed, and a method for producing a feed for feeding a fish or crustacean.

### Description of Related Art

Aquaculture, commonly referred to as aquafarming, involves the farming of aquatic animals. This dynamic and rapidly evolving industry has become a growing contributor to the production of food for human consumption, but also for the provision of processed materials obtained from the aquatic animal.

A hatchery serves as a facility for the artificial breeding, hatching, and early-stage rearing of various animals, with a particular emphasis on fish and crustaceans. Once nurtured through these initial life stages, the animals are then transferred to on-growing systems or farms until they reach a harvestable size, suitable for human consumption or for other types of processing.

Maximizing biomass production efficiency (i.e. increase of biomass per time) is a key goal in aquaculture, reflecting the efficiency and success of the operation. Factors influencing biomass production efficiency include feed quality, environmental conditions, disease management, feeding practices, and overall management strategies employed in the aquaculture system. Tracking and optimizing biomass production efficiency are crucial for sustainable aquaculture practices, ensuring adequate yields while maintaining environmental sustainability and animal welfare. Maximizing biomass production efficiency stands as a primary goal in aquaculture. Achieving this involves strategies aimed to enhance the weight gain of aquatic animals per time (weight gain speed) and lowering mortality rates (i.e., increasing survival rate). Among the various approaches to boost biomass production efficiency, e.g. by improving water quality or improving veterinary care, the choice of feed type emerges as a crucial factor.

While biomass production efficiency is a quantitative measure, another aspect of relevance in the aquafarming is the quality and composition of the produced biomass. It would be desirable to improve biomass production not only by maximizing biomass production per se (biomass production efficiency), but also to obtain biomass of higher quality, expressed as an increased content, e.g. expressed in wt. % relative to the total weight of biomass, of desirable components of the biomass. This is because aquatic animals and processed products obtained therefrom are often purchased by consumers in order to contribute to a healthy diet, as these can be rich in desired components such as polyunsaturated fatty acids (PUFAs), in particular [symbol] 3 PUFAs. Such compounds are known to be beneficial e.g., in the prevention or treatment of cardiovascular diseases. Aquatic animals are also used to obtain processed products, such as extracts of EPA and DHA that are obtained from marine oils and which are commercialized e.g. as food supplements. An aquatic animal having an increased PUFA content has thus a higher commercial value, so that means for increasing PUFA content in animals obtained by aquafarming are highly desired.

In light of this, the consistent exploration of novel products, compositions, methods, and applications for aquaculture feed, especially designed for nourishing the early life stages of fish and crustaceans (larvae), is deemed highly advantageous. There is a distinct demand within the field for dependable, efficient, and reproducible products, compositions, methods, and applications tailored for use in the cultivation of aquatic animals, particularly fish and crustaceans like shrimp, especially during the nurturing of their larvae.

A feed for use in aquaculture preferably is easy to administer and distribute and has long shelf life. This can often be achieved by feeds in solid form, preferably in the form of a free-flowing mass or particulate materials, such as pellets. The formed mass or pellets may have a size, stability and floatability characteristics required in the different life stages of the aquatic animals and/or may have a size, stability and floatability characteristics that facilitates handleability of the feed during production, storage and/or use.

As one example of conventional aquaculture feed compositions, WO 2022/182248 A1 entitled “AQUACULTURE FEED COMPOSITION COMPRISING CHARCOAL” describes an aquaculture feed composition in the form of pellets comprising more than 60 wt. % protein and further comprising charcoal. Conventional aquaculture feed compositions frequently incorporate fish and/or vegetable oils in the pellets. But incorporating lipids in the form of oils has several disadvantages, as will be described below.

The composition described in WO 2022/182248 A1 can comprise at least 2.2 wt. % of charcoal, but it is not disclosed whether or not higher concentrations of charcoal increase survival and biomass of the aquatic animals. In addition, augmented amounts of charcoal pose a drawback by diluting the feed's nutrients and subsequently diminishing the overall energy content of the feed.

As another example, the use of dry “soap powders” of omega-3 fatty acids to feed the brine shrimp Artemia has been disclosed in U.S. Pat. No. 6,261,590 entitled “METHODS FOR THE ENRICHMENT OF LIVE FEED WITH NUTRIENTS ESSENTIAL FOR FISH LARVAE”. The authors describe that that the “soap powders” did not exhibit any positive impact on the length, weight, and survival rate of the animal, as disclosed in the paragraph following table 6, and is toxic to Artemia when used in emulsion form. The utilization of powdered soap did not contribute to the augmentation of biomass or the improvement of survival rates in Artemia.

The “soap powders” disclosed in U.S. Pat. No. 6,261,590 are derived from a byproduct lipid composition extracted from the alkaline wash of fish oil and algae oil. This lipid composition, known in the industry as “soaps”, same term used by the authors of U.S. Pat. No. 6,261,590, is a mixture mainly composed of 45% triglycerides, 28% of free fatty acids and 21% of phospholipids (see table 1 of the patent). The authors of the patent prepared a “soap powder” by washing the “soaps” with cold acetone at pH 4.0 and recovering the solids or “acetone washed soap”. This “soap powder” is mainly composed of phospholipids and fatty acids. Then the authors discovered that when directly using this “soap powder” in a tank with Artemia allows the enrichment of the later in contrast of using the soap powder in an emulsion, which showed toxicity. Therefore, the fatty acids of the “soap powder” composition disclosed in U.S. Pat. No. 6,261,590 are mainly in acid form or esterified, like in phospholipid or triglyceride form, but not in the form of fatty acid salts.

In addition, Artemia and penaeid shrimps, or just shrimps, are two different aquatic organisms, and they have several key biologic differences, including their taxonomy. For example, Artemia can efficiently utilize omega-3 fatty acid ethyl esters (see Table 5 and lines 40-50 of U.S. Pat. No. 6,261,590). In contrast, shrimps poorly digest and/or metabolize methyl or ethyl esters of fatty acids and their growth with free fatty acids is markedly lower than with triglycerides (Brett D. Glencross and David M. Smith. “Comparison of triacylglycerols, esterified and free fatty acids as neutral lipid sources in the diet of the prawn Penaeus monodon” Aquaculture, Volume 159, issues 1-2, 30 Dec. 1997, pages 67-85).

In rainbow trout it has been shown that fatty acid ethyl ester oils can be used to replace 25% of fish oil in starter diets without having a significant effect on fish growth or performance, but at higher levels (250%) caused reduced growth and feed conversion efficiency. See John Grayson, Konrad Dabrowski “Partial and total replacement of fish oil with fatty acid ethyl esters in the starter diets of rainbow trout (Oncorhynchus mykiss)” Aquaculture, Volume 522, 30 May 2020, 735018.

An additive for pet food, comprising at least one unsaturated fatty acid calcium salt and antioxidant caramel have been disclosed in JP2014138564A, entitled “Pet food, and additive for pet food and method for producing the same”. At least one unsaturated fatty acid calcium salt is mixed together with a caramel antioxidant obtained by heating an aqueous solution of a monosaccharide selected from the group consisting of pentose and hexose.

JPH06319465A, entitled “Feed and its production”, describes a feed comprising omega 3 fatty acids in free form obtained from neutralizing a saponified substance comprising omega 3 fatty acids. The feed is used for livestock such as cattle, a pig or a chicken or a pet such as dog, cat, or a small bird.

EP 1 800 546 A1 entitled “Method of producing calcium, sodium or magnesium soaps from fatty acids or oleins from animal or vegetable fats and use thereof as nutrients in monogastric animal feed” discloses the use of these soaps in monogastric animals, such as pigs and fowl, decreases feeding costs compared to the use of whole fats (triglycerides) commonly used in the nutrition of monogastric.

### OBJECTS OF THE INVENTION

One object of the invention is to provide means for increasing the biomass production efficiency of an aquatic animal in a hatchery or farm of the aquatic animal.

Another object of the invention is to provide means for increasing the survival rate of aquatic animals held in a hatchery or farm of the aquatic animal.

Another object of the present invention is to provide means for increasing the content of ω̅3 polyunsaturated fatty acids in an aquatic animal held in a hatchery or farm or in a processed product obtained therefrom.

Another object of the present invention is to improve the utilization of raw materials obtained from plants or from aquatic animals, the aquatic animals being held in a hatchery or farm or being obtained from natural habitats.

Another object of the invention is to provide a feed for an aquatic animal formed mass or pellets that may have a size, stability and floatability characteristics required in the different life stages of the aquatic animals and/or may have a size, stability and floatability characteristics that facilitates handleability of the feed during production, storage and/or use.

Another object of the invention is to provide a diluent or carrier for mineral, vitamin and other premixes present in the feed, which may be in pellet form.

Another object of the present invention is to provide a feed that provides benefits in terms of simple logistics, production, storage, and shelf life.

Other advantages and objects of the present invention will become apparent in light of the following disclosure.

### SUMMARY OF THE INVENTION

These and other objects of the invention have been achieved by the invention are hereinafter described. The invention is based on the surprising finding that increase in biomass production and survival of the aquatic animals, preferably of a larva of a fish and/or a crustacean, both in hatcheries and farms, is higher with increasing concentrations of alkali metal salts of fatty acids in the feed. It was further surprisingly found that with such a feed the content of PUFAs in the aquatic animal can be increased.

The present invention includes the following embodiments:
1. A method for feeding a crustacean or fish in a hatchery or farm of the crustacean or fish, the method comprising feeding the fish or crustacean with a feed comprising one or more alkali metal salts of fatty acids.
2. The method of embodiment 1, wherein the alkali metal of the alkali metal salts of fatty acids is selected from the group consisting of sodium, potassium and mixtures thereof.
3. The method of any one of embodiments 1 and 2, wherein the crustacean is Pacific White Shrimp, Black Tiger Shrimp, Indian White Shrimp, Kurume Shrimp, Northern White Shrimp, Banana Shrimp, Chinese White Shrimp or Kona Shrimp, Giant River Prawn or Giant Tiger Prawn.
4. The method of embodiment 1 or 2, wherein the fish is Carp, Tilapia, Carassius, Roho, Trout, Wuchang bream, Salmon, Milkfish, Coho, or Seabass.
5. The method of any of the preceding embodiments, wherein the one or more alkali metal salts of fatty acids comprise alkali metal salts of one or more monounsaturated or polyunsaturated fatty acids, in particular C16-C30 monounsaturated or polyunsaturated fatty acids, and wherein preferably the amount of alkali metal salts of monounsaturated or polyunsaturated fatty acids is 10% by weight or more, relative to all fatty acids forming alkali metal salts of fatty acids.
6. The method of any of the preceding embodiments, wherein the fatty acids of the alkali metal salts of fatty acids derive from a marine oil and comprise at least three fatty acids selected from palmitic acid, palmitoleic acid, stearic acid, oleic acid, linoleic acid, alphalinolenic acid, arachidonic acid, eicosapentaenoic acid and docosahexaenoic acid.
7. The method of embodiment 5 or 6, wherein the weight % of the alkali metal salts of fatty acids are as follows: alkali metal salts of palmitic acid between 0.1-80%, alkali metal salts of palmitoleic acid between 0.1-50%, alkali metal salts of stearic acid between 0.1-50%, alkali metal salts of oleic acid between 0.1-80%, alkali metal salts of linoleic acid sops between 0.1-80%, alkali metal salts of alpha linolenic acid between 0.1-80%, alkali metal salts of arachidonic acid between 0.1-20%, alkali metal salts of eicosapentaenoic acid between 0.1-60%, alkali metal salts of docosahexaenoic acid between 0.1-60%, and between 1-25% of one or more alkali metal salts of fatty acids selected from the group consisting of C14:0, C20:0, C22:0, C24:0, C26:0, C18:1 n-7, C20:1 n-9, C22:1 n-9, C22:1 n-11, C24:1 n-11, C18:4 n-3, C20:2 n-6, C20:4 n-3, C21:5: n-3, C22:5 n-6, C22:5 n-3, C24:4 n-3, C24:5 n-3, C24:6 n-3, C26:4 n-3, C26:5 n-3, C26:6 n-3, C26:7 n-3, C28:4 n-3, C28:5 n-3, C28:6 n-3, C28:7 n-3, C28:8 n-3, C30:5 n-3 and C30:6 n-3; and wherein the weight % of the alkali metal salts of fatty acids are expressed relative to the total content of fatty acid salts in the feed.
8. The method of any one of embodiments 5 to 7, wherein the fatty acids forming the alkali metal salts of fatty acids derive from a byproduct obtained in a process for producing a concentrate of EPA and/or DHA from a marine oil.
9. The method of embodiments 1 to 7, wherein the fatty acids of the alkali metal salts of fatty acids derive from vegetable oil, such as linseed oil, or mixtures of one or more vegetable oils and one or more marine oils or marine oil processed products, such as from a mixture of linseed oil and a product or byproduct from a process for producing EPA and DHA concentrates from marine oil, e.g. the heavy fraction.
10. The method of any one of embodiments 1 to 9, wherein the feeding is conducted continuously or intermittently multiple times daily, such as 2-12 times daily.
11. The method of any one of embodiments 1 to 10, wherein the feed comprises between 0.5 and 40% by weight of alkali metal salts of fatty acids, relative to the total weight of the feed.
12. The method of any one of embodiments 1 to 11, which leads to an increase in biomass growth and/or survival rate and/or omega-3 fatty acid content of the crustacean or fish relative to a crustacean or fish receiving the same amount of a feed containing the same amount (expressed in g/day) of oil instead of the alkali metal salts of fatty acids.
13. The method of any one of embodiments 1 to 12, wherein the feed is in powder or pellet form.
14. The method of any one of embodiments 1 to 13, wherein the feed further additionally comprises one or more components selected from the group consisting of animal protein, plant protein, carbohydrates, vitamins, minerals, cholesterol, and lecithin.
15. Feed for a fish or crustacean comprising one or more alkali metal salts of fatty acids or being made from a composition comprising one or more alkali metal salts of fatty acids.
16. Feed according to embodiment 15, wherein the alkali metal of the one or more alkali metal salts of fatty acids is selected from the group consisting of sodium, potassium and mixtures thereof.
17. Feed according to embodiment 15 or 16, wherein the fatty acids forming the alkali metal salts of fatty acids comprise monounsaturated or polyunsaturated fatty acids, in particular C16-C30 monounsaturated or polyunsaturated fatty acids, and wherein preferably the amount of monounsaturated or polyunsaturated fatty acids is 10% by weight or more, relative to all fatty acids forming alkali metal salts of fatty acids.
18. Feed according to any one of embodiments 15 to 17, wherein the fatty acids of the one or more alkali metal salts of fatty acids derive from a marine oil and comprise at least three fatty acids selected from palmitic acid, palmitoleic acid, stearic acid, oleic acid, linoleic acid, alpha linolenic acid, arachidonic acid, eicosapentaenoic acid and docosahexaenoic acid.
19. Feed according to any one of embodiments 15 to 18, wherein the fatty acids forming the one or more alkali metal salts of fatty acids derive from a byproduct obtained in a process for producing a concentrate of EPA and/or DHA from a marine oil.
20. Feed according to any one of embodiments 15 to 17, wherein the fatty acids of the one or more alkali metal salts of fatty acids derive from vegetable oil, such as linseed oil, or mixtures of one or more vegetable oils and one or more marine oils or marine oil processed products, such as from a mixture of linseed oil and a byproduct from a process for producing EPA and DHA concentrates from marine oil, e.g. the heavy fraction.
21. Feed according to any one of embodiments 15 to 20, wherein the weight % of the alkali metal salts of fatty acids are as follows: alkali metal salts of palmitic acid between 0.1-80%, alkali metal salts of palmitoleic acid between 0.1-50%, alkali metal salts of stearic acid between 0.1-50%, alkali metal salts of oleic acid between 0.1-80%, alkali metal salts of linoleic acid sops between 0.1-80%, alkali metal salts of alpha linolenic acid between 0.1-80%, alkali metal salts of arachidonic acid between 0.1-20%, alkali metal salts of eicosapentaenoic acid between 0.1-60%, alkali metal salts of docosahexaenoic acid between 0.1-60%, and between 1-25% of one or more alkali metal salts one or more fatty acids selected from the group consisting of C14:0, C20:0, C22:0, C24:0, C26:0, C18:1 n-7, C20:1 n-9, C22:1 n-9, C22:1 n-11, C24:1 n-11, C18:4 n-3, C20:2 n-6, C20:4 n-3, C21:5: n-3, C22:5 n-6, C22:5 n-3, C24:4 n-3, C24:5 n-3, C24:6 n-3, C26:4 n-3, C26:5 n-3, C26:6 n-3, C26:7 n-3, C28:4 n-3, C28:5 n-3, C28:6 n-3, C28:7 n-3, C28:8 n-3, C30:5 n-3 and C30:6 n-3; and wherein the weight % of the alkali metal salts of fatty acids are expressed relative to all fatty acids forming alkali metal salts of fatty acids.
22. Feed according to any one of embodiments 15 to 21, wherein the feed comprises between 0.5 and 40% by weight of alkali metal salts of fatty acids, relative to the total weight of the feed.
23. Feed according to any one of embodiments 15 to 22, which is in powder or pellet form.
24. Feed according to any one of embodiments 15 to 23, wherein the feed further comprises one or more components selected from the group consisting of animal protein, plant protein, carbohydrates, vitamins, minerals, cholesterol, and lecithin.
25. Use of alkali metal salts of fatty acids, or of a feed comprising alkali metal salts of fatty acids as defined in any one of embodiments 15 to 23, for increasing biomass production, survival rate and/or omega 3 fatty acid content of a crustacean or fish in a hatchery or farm.
26. The method for feeding a crustacean or fish in a hatchery or farm of the crustacean or fish, the feed or the use according to any of embodiments 1 to 25 above, wherein the method, the feed or the use is, or is suitable for, increasing biomass production efficiency in the hatchery or farm.
27. The method for feeding a crustacean or fish in a hatchery or farm of the crustacean or fish, the feed or the use according to any of embodiments 1 to 25 above, wherein the method, the feed or the use is, or is suitable for, increasing the survival rate of the crustacean or fish.
28. The method for feeding a crustacean or fish in a hatchery or farm of the crustacean or fish, the feed, or the use according to any of embodiments 1 to 25 above, wherein the method, the feed or the use is, or is suitable for, increasing the content of PUFAs in the fish or crustacean.
29. A method for producing a processed product from a fish or crustacean, the method comprising:
   a. Feeding a fish or crustacean or fish employing the method according to any one of embodiments 1 to 14, and
   b. Processing the fish or crustacean such as to obtain a desired product.
30. The method according to embodiment 29, wherein the processing step b. comprises a purification step to obtain a product comprising PUFAs, such as for producing a product comprising more than 1% by weight of EPA and/or DHA, such as 10% by weight or more, relative to the total weight of the product.
31. A method for producing a feed for feeding a fish or crustacean as defined for any of embodiments 15 to 24, which comprises mixing one or more alkali metal salts of fatty acids or a composition comprising one or more alkali metal salts of fatty acids with one or more other compositions, said other compositions comprising one or more components selected from the group consisting of animal protein, plant protein, carbohydrates, vitamins, minerals, cholesterol, lecithin, or said other composition being a marine oil processed product, such as a product or byproduct from a process for producing EPA and DHA concentrates from marine oil, e.g. the heavy fraction.
32. The method for producing a feed according to embodiment 31, which further comprises one or more steps selected from heating, homogenizing, pelletizing, extruding, drying or packaging the material obtained from the mixing step.
33. The method for producing a feed according to embodiment 31 or 32, wherein the composition comprising one or more alkali metal salts of fatty acids comprises at least three fatty acids selected from palmitic acid, palmitoleic acid, stearic acid, oleic acid, linoleic acid, alpha linolenic acid, arachidonic acid, eicosapentaenoic acid and docosahexaenoic acid, and optionally further contains cholesterol.
34. A feed obtained by the method according to any one of embodiments 31 to 33.
35. Use of the feed according to embodiment 33 in a method as defined in any one of embodiments 1 to 14.
36. Use of a composition comprising one or more alkali metal salts of a fatty acids for producing a feed for feeding a crustacean or fish.

### Definitions

Though the terms used in the following generally have their common meaning in the art, the following definitions and restricted meanings apply, unless indicated differently:

In the present invention, the term “feed” is a material or composition that is intended to be used to nourish aquatic animals by ingestion. The term encompasses both materials and compositions that are used solely without other nourishing materials, but also encompasses supplements that are provided to the aquatic animal in addition to other sources of nutrition. The term encompasses both a “complete feed” and an “additive feed” as defined below.

The term “fatty acid” denotes carboxylic acids that are or can be obtained by hydrolysis of fats and oils of animal or plant origin. Fats and oils contain the fatty acids mainly in the form of triglycerides. Fatty acids may be represented by the general formula R—COOH, wherein R is a straight or branched aliphatic hydrocarbon (alkyl or alkenyl) group having 12 to 36 carbon atoms.

The term “saturated fatty acid” (SAFA) denotes compounds of formula R—COOH, wherein R is a straight or branched, typically straight, alkyl group having 12 or more, such as 12 to 36 or 14 to 30 carbon atoms.

The term “monounsaturated fatty acid” (MUFA) denotes compounds of formula R—COOH, wherein R is a straight or branched, typically straight, alkenyl group having 12 or more, such as 12 to 36 or 14 to 30 carbon atoms and containing 1 carbon-carbon double bond.

The term “polyunsaturated fatty acid” (PUFA) denotes compounds of formula R—COOH, wherein R is a straight or branched, typically straight, alkenyl group having 12 to 36 carbon atoms and containing 2 or more carbon-carbon double bonds, such 2 to 8 carbon-carbon double bonds or 2 to 6 carbon-carbon double bonds. Examples of PUFAs include eicosapentaenoic acid (EPA), docosahexaenoic acid (DHA) and arachidonic acid (ARA).

The term “very long chain polyunsaturated fatty acid” (VLCPUFA) denotes polyunsaturated fatty acids having 24 to 36 carbon atoms and containing 2 or more carbon-carbon double bonds, such as 2 to 8 carbon-carbon double bonds or 2 to 6 carbon-carbon double bonds.

The term “ω̅3 fatty acid” is used to denote a MUFA, PUFA or VLCPUFA that has a carbon-carbon double bond located at the third carbon atom from the methyl end (omega-3 position).

The term “crustacean” is used in the present invention to denote animals that belong to the subphylum Crustacea and whose natural habitat is saltwater or freshwater. Examples include crab, lobster, shrimp, crayfish, and prawn.

The term “fish” is used in the present invention to denotes animals included in the paraphyletic group called Pisces and encompasses both freshwater and saltwater fish. In the present invention, the term “fish” additionally encompasses shellfish that are not crustaceans, such as mollusks, whose natural habitat is saltwater or freshwater, which are not encompassed by the paraphyletic group Pisces. Examples in the group Pisces include Carp, Tilapia, Carassius, Roho, Trout, Wuchang bream, Salmon, Milkfish, Coho, or Seabass. Examples of shellfish that are not crustaceans include oysters, clams, scallops and mussels.

The term “hatchery” denotes a facility where fish or crustaceans are bred, hatched, and raised under controlled conditions.

The term “farm” is used to denote a facility where fish or crustaceans are bred, raised, and harvested in controlled environments for commercial, recreational, or conservation purposes. Fish or crustacean farming is a form of aquaculture that involves the cultivation of fish or crustaceans in tanks, ponds, raceways, or other enclosed systems. A farm typically includes a water management system, such as embodied by pumps and oxygen supply means, and optionally a feeding system and a health monitoring system.

The term “alkali metal” is used in the present invention to denote lithium, sodium, potassium and rubidium. In one embodiment, the alkali metal is lithium, sodium, potassium, or mixtures thereof, and in one embodiment the alkali metal is selected from sodium and potassium and mixtures thereof.

The term “alkali metal salt of a fatty acid” is to denote a salt formed from an alkali metal cation and a fatty acid anion, where the alkali metal and the fatty acid are defined as above. The term encompasses alkali metal salts of SAFAs, MUFAs, PUFAs and VLCPUFAs. Specific example of alkali metal salt of a fatty acid includes sodium stearate or potassium docosahexaenoate.

The term “oil” is used as an umbrella term used to cover fats and oils, i.e. compositions mainly formed by triglycerides, irrespective of their melting point. An oil may consist of only triglycerides but may also contain minor amounts (e.g. 15% by weight or less, such as 10% by weight or less or 5% by weight or less) of one or more of free fatty acids, phospholipids, and optionally other lipids like sterols.

The term “glyceride” refers to mono-glycerides, di-glycerides, triglycerides, and mixtures thereof, and thus denotes esters of glycerol with one or more fatty acids. The fatty acid moiety could be any fatty acids as SAFAs, MUFAs, PUFAs and VLCPUFAs.

The term “marine oil” is used to denote an oil as defined above derived from animals or plants having their natural habitat in the sea or freshwater. In one embodiment, the marine oil is derived from fish and crustaceans as defined above whose natural habitat is saltwater. A marine oil typically contains triglycerides having a fatty acid moiety that is formed by at least one of MUFAs and PUFAs.

The term “oil processed product” is used to denote a processed product obtained from oils. An oil processed product typically contains at least one of MUFAs and PUFAs or derivatives thereof wherein the MUFA or PUFA moiety is present in a form other than triglyceride form, e.g., as free fatty acid, fatty acid alkyl (typically methyl or ethyl) ester, or fatty acid salt or adduct. In an “oil processed product”, triglycerides may be fully absent or may be included in an amount of 80% by weight or less, such as 50% by weight or less, e.g. 10% by weight or less.

A specific form of a marine oil processed product are the by-product fractions from the Omega 3 Industry. Typically, a distillate fraction (or “light fraction”) is obtained from a distillation process of marine oils, and a heavy residue (or “heavy fraction”) is obtained in a distillation process of a fatty acid alkyl ester composition derived from marine oil. The light fraction and/or the heavy fraction, which do not contain the majority of the desired compounds (such as EPA and/or DHA), are often discarded. These fractions represent valuable sources of alkali metals salts of fatty acids for the present invention. Here, the alkali metal salts of fatty acids may be obtained by hydrolyzing the light fraction or heavy fraction and forming salts with bases such as sodium hydroxide or potassium hydroxide.

The term “heavy fraction”, when it refers to a fraction (residue or distillate) that is obtained in the distillation of marine oil processed products, in particular fatty acid alkyl (in particular methyl or ethyl) esters, denotes a fraction (residue or distillate) that contains between 0.1 to 10% by weight of free fatty acids (typically having a carbon chain length of 20 or more, such as 20 to 36 or 22 to 30), 20 to 60% of glycerides, 20 to 60% by weight of fatty acid alkyl ester (wherein the fatty acid moiety typically has 18 to 36 carbon atoms, such as 20 to 30 carbon atoms) and 2 to 40% by weight of cholesterol.

The term “light fraction”, when it refers to a fraction (residue or distillate) that is obtained in the distillation of marine oil, in particular crude marine oils or mixtures of crude marine oils, denotes a fraction (residue or distillate) that contains between 30 to 90% of free fatty acids, 0.1 to 10% of glycerides, 0.1 to 60% of fatty acid alkyl and 1 to 20% of cholesterol.

The term “powder” denotes a particulate matter having an average particle size of 1 mm or less, the average particle size being defined as D₅₀ in a volume-based particle size distribution as obtained by a method common in the art, e.g. by sieve analysis or laser light scattering.

The term “pellet” denotes a particulate matter having an average particle size of more than 1 mm, such as 1.5 mm or more or 2 mm or more. Here, the average particle size is defined as D₅₀ in a volume-based particle size distribution as obtained by a method common in the art, e.g. by sieve analysis or laser light scattering. The pellet may be round or cylindrical and is typically obtained by compressing and/or extruding a mass of material. A cylindrical pellet may have a longest axis of 1 mm or more, such as 2 mm or more, and typically 5 cm or less, such as 2 cm or less. A cylindrical pellet may have a diameter that is between 0.1 to less than 1 times the longest axis.

The term “premix” denotes a composition that is to be processed further by mixing with other components, e.g., to prepare a complete feed.

The term “biomass” refers to the total weight of an animal, such as an animal grown in a hatchery or farm.

The term “biomass production efficiency” refers to the total growth of biomass in a hatchery or farm over a given period of time, e.g. per month, per week or per day, relative to the number of animals at the beginning of the period of time. This term thus not only reflects the weight gain of individual animals, but also the survival rate of the animals.

The term “survival rate” is defined as relative number of animals surviving a given time period, e.g. a month, a week, or a day, and may be assessed following the protocol described in the Examples section below.

The term “complete feed” is used to denote a feed that is intended to provide the majority of energy (expressed in Joule) to a fish or crustacean fed with the complete feed. Here, the majority of energy is defined as being 50% or more of total energy fed to the fish or crustacean, such as 60% or more, such as 70% or more, and up to 100% or less, such as 95% or less.

The term “additive feed” is used to denote a feed that is intended to provide the minority of energy (expressed in Joule) to a fish or crustacean, which is typically fed as a supplement in combination with a complete feed. Here, the minority of energy is defined as being less than 50% of total energy fed to the fish or crustacean, such as 45% or less or 40% or less, but typically 1% or more, 3% or more, 5% or more or 10% or more.

The term “minor component” is used to denote a component having a content of less than 1% by weight or less, such as 0.9% by weight or less, 0.5% by weight or less, or 0.1% by weight or less, relative to the total weight of the composition (or feed).

The term “major component” is used to denote a component having a content of 1% by weight or more, such as 5% by weight or more or 10% by weight or more, relative to the total weight of the composition (or feed).

The term “one or more” means one, or more than one, such as two or more, three or more, four or more, or five or more. The term “at least one” has the same meaning.

The term “comprising” is used to denote that a composition of matter contains the respective material, yet the presence of additional components is not excluded. The term however also encompasses the meanings “consisting of” and “essentially consisting of”, except where it is clear form the context that other components are required. Here, the term “essentially consisting of” generally means that other component(s) than those recited may be present in an amount of typically 10% by weight or less of the respective component.

When ranges are defined in the present invention by upper and lower limits, such as “from 2 to 5”, the ranges include the indicated upper and lower limit and any value in between.

### DESCRIPTION OF THE INVENTION

Aquaculture typically requires a prepared aquaculture feed composition to meet dietary requirements of the cultured animals and to provide the essential nutrients required for the growth and health of the cultured aquatic organisms. Further, dietary requirements of different aquaculture species vary, as do the dietary requirements of a single species during different stages of growth.

Standard aquaculture complete feeds are composed of minor and major components. The minor components include vitamins, cholesterol, minerals, trace minerals, antibiotics, mold inhibitors and flavors, and are predominantly added in the form of premixes in the range of 1 kg to 50 kg per ton of complete feed. They are premixed with some suitable diluent or carrier, organic or inorganic, to achieve a homogeneous distribution of the minor components in the complete feed.

Both major and minor components of a complete feeds are subdivided into components with nutritional functions and technical functions. Components with technical functions improve the physical quality of the aquaculture feed composition or its appearance, or may aid processing, manufacture or handling, whereas components with nutritional function provide the aquatic animal to be fed with energy and essential and beneficial components such as vitamins, minerals, and optionally pharmaceutical agents such as antibiotics.

Major components with nutritional functions provide aquatic animals with protein and energy required for growth and performance. The major components of a complete feed having nutritional function typically include:
1) Proteins and amino acids, which serve as building blocks of proteins.

Suitable protein sources include marine protein such as fish meal, krill meal, squid meal, vegetable proteins such as soy meal, rape seed meal, wheat gluten, corn gluten, lupine meal, pea meal, sunflower seed meal, rice meal, alfalfa meal, and slaughterhouse waste such as blood meal, bone meal, feather meal, and chicken meal poultry meal, egg powder, liver meal, meat meal, meat and bone meal, silkworm pupae meal, whey powder, etc.

Protein hydrolysates are commonly used in aquaculture feeds as a source of high-quality protein. These hydrolysates are derived from the enzymatic or chemical breakdown of proteins into smaller peptides and amino acids, making them more digestible for aquatic species. Types of commonly protein hydrolysates are Fish hydrolysate, Shrimp hydrolysate, Squid hydrolysate, Krill hydrolysate, Soy Protein hydrolysate, Wheat Gluten hydrolysate, Casein hydrolysate, Alfalfa hydrolysate, Bacterial hydrolysate, Enzymatic hydrolysates, among others. Protein hydrolysates are valued in aquaculture for their digestibility, amino acid content, and contribution to overall feed efficiency.

By mixing different protein and protein hydrolysates sources it is possible to achieve a desired protein content and amino acid profile adapted to the species of aquatic animal and life stage the feed is intended for.
2) Lipids which serve as a source of fatty acids for energy (especially for heart and skeletal muscles).

Lipids also assist in vitamin absorption; for example, vitamins A, K, D, E and K are fat-soluble or can only be digested, absorbed, and transported in conjunction with fats.

Suitable lipid sources include animal oils like fish oil, krill oil, squid oil, and/or vegetable oils such as rapeseed oil, soy oil, linseed oil, sunflower oil, olive oil and other sources like microbial oil, algal oil, and insect oils. As will be understood by the skilled person, such oils may be present in meals as well (e.g. fish meal, algal meals). By mixing different oils it is possible to achieve a desired fatty acid profile and total lipid content in the feed adapted to the species of aquatic animal the feed is intended for.

Other suitable lipids include animal or vegetable oil processed products obtained from by-products streams from the fish oil and vegetable oil refining industries, like streams comprising oils, free fatty acids or fatty alkyl esters from the neutralization process of oils or the distillate fraction of high vacuum distillation of oils (stripping process), streams comprising stearin from the winterization processes, streams comprising fatty acid ethyl or methyl esters from the omega 3 industry, such as the heavy fraction from the distillation of omega 3 alkyl fatty acids.

Other suitable lipids include animal oils (fats) from the rendering industry.

Examples of marine oils are fish oil, typically derived from the tissues of an oily fish including menhaden, anchovy, sardine, herring, capelin, cod, tuna, mackerel, salmon and the like, or vegetable oil which refers to any crude or edible oil obtained from a plant including soybean oil, sunflower oil, canola oil, olive oil, corn oil, palm oil, coconut oil, safflower oil, linseed oil, rapeseed oil, rice oil and the like, or fats and oils from the rendering industry or by-products streams form the oil refining and concentrating industry, like the omega 3 industry, or restaurant grease or microbial oil or algal oil or any mixture of the aforementioned fats and oil. Typically plant oil is extracted from seed or grain of a plant. Oils are incorporated to the aquaculture feed composition typically in liquid form.

Lipids are important as an energy source providing more calories per gram compared to carbohydrates and proteins, but most importantly they are a source of essential fatty acids of the omega-3 and omega-6 series like linoleic acid (LOA), alpha linolenic acid (LNA), arachidonic acid (ARA), eicosapentaenoic acid (EPA) and docosahexaenoic acid (DHA). These are vital for the development of cell membranes, as well as various biological processes, including reproduction, immune response, and overall health. Fish and shrimp cannot synthesize these fatty acids and must obtain them from their diet.

In the state of art, standard aquaculture feed compositions for aquatic animals comprising animal or vegetable oils, all fatty acids, both essential and non-essential fatty acids are found typically in the form of triacylglycerides, which refers to neutral lipids composed of three fatty acyl residues esterified to a glycerol molecule, but also in phospholipids. Most neutral lipids contain also minor amounts of mono-glycerides, di-glycerides and free fatty acids as well. These may be naturally occurring but mostly they are results of various processes causing modification of the triacylglycerols.

Phospholipids such as phosphatidylcholine, phosphatidylethanolamine, and phosphatidylinositol, are the most common phospholipid classes present in the lipid blends known as “lecithins” represent more than 50% of the total lipids of the lecithin. The vegetal lecithins contain C18 fatty acids from n-3 and n-6 essential fatty acid series (linoleic acid C18:2 n-6 and linolenic acid C18:3 n-3) but are essentially free from C20 and C22 polyunsaturated fatty acids, including arachidonic acid (20:4 n-6), eicosapentaenoic acid (EPA, C20:5 n-3) and docosahexaenoic acid (DHA, C22:6 n-3). This does not limit the use of lecithins as the latter fatty acids can be supplied, separately from added lecithins, by other feed ingredients. Commercial lecithins are available in both powdered and liquid form.
3) Carbohydrates.

Carbohydrates play a significant role in aquaculture feeds, providing a valuable source of energy for aquatic organisms. Typically, carbohydrates used in aquaculture feeds are mainly of plant origin (e.g., wheat, sunflower, corn, soybean).

Some of the feeds may contain fibers, binders, and stabilizers as well to improve pellet quality and durability of the feed, probiotics and prebiotics and in the case of certain species colorants may be added to the feed, as well as attractants, hormones, enzymes and immunostimulants.

It was surprisingly found that alkali metal salts of fatty acids can replace either partially or totally fats and oils in standard aquaculture feeds compositions, and the increase of the level of substitution, compared to a standard feed, result also in an increase of biomass production among the aquatic animal fed with the aquaculture feed composition of the invention. In particular, the increase of biomass production may be also accompanied with an increase in survival (or decrease in mortality), which both contribute to an improved Feed Conversion Rate (FCR) in comparison to a standard aquaculture feed composition characterized by the absence of alkali metal salts of fatty acids in the feed composition.

Essential fatty acids (EFAs) are a specific type of fatty acid that cannot be synthesized by aquatic animals, in particular fish and crustaceans as shrimp and must be obtained through their diet.

In this invention the term crustacean encompasses both shrimp and prawn although there are some general characteristics which differentiate them including claw and body structure, habitat and size, however, both have a similar life cycle (eggs, nauplii, zoea, mysis, larva, postlarvae, juvenile and adult) and both can utilize the feed of the invention to the same surprising effect as disclosed herein.

Non-essential fatty acids also play a vital role in the nutrition and physiology of aquatic animals, in particular fish and crustaceans as shrimp, that serve various functions in the body, including providing a source of energy, forming cell membranes, and serving as precursors for important signaling molecules. In the state of art, standard aquaculture feed compositions for aquatic animals comprising animal or vegetable fats and oils, all comprising fatty acids, both essential and non-essential fatty acids are found typically in the form of triacylglycerols, which refers to neutral lipids composed of three fatty acyl residues esterified to a glycerol molecule, but also in phospholipid form. Most lipids contain also small amounts of mono-glycerides, di-glycerides, and free fatty acids as well. These may be naturally occurring but mostly are results of various processes causing hydrolysis of the triacylglycerols.

Phospholipids such as phosphatidylcholine, phosphatidylethanolamine, and phosphatidylinositol, are the most common phospholipid classes present in the lipid blends known as “lecithins” represent more than 50% of the total lipids of the lecithin. The vegetal lecithins contain C18 fatty acids from n-3 and n-6 essential fatty acid series (linoleic acid C18:2 n-6 and linolenic acid C18:3 n-3) but are essentially free from C20 and C30 polyunsaturated fatty acids, including arachidonic acid (C20:4 n-6), eicosapentaenoic acid (EPA, C20:5 n-3) and docosahexaenoic acid (DHA, C22:6 n-3). This does not limit the use of lecithins as the latter fatty acids can be supplied, separately from added lecithins, by other feed ingredients. Commercial lecithins are available in both powder and liquid forms.

A typical standard aquaculture feed composition will comprise from about 2-40% of total lipid content or crude lipid content, mainly in the form of triglyceride (e.g., fish oil, vegetable oil, algae oil etc.), measured as a weight percentage of the aquaculture feed composition. Roughly 85% of lipids are fatty acids. Standard aquaculture feed compositions do not contain fatty acids in the form of alkali metal salts of fatty acids.

Aquaculture feed compositions are elaborated into a sizeable formed mass or pellets. But incorporating liquid oils with dry ingredients (proteins, carbohydrates) into pellets feeds can present many challenges due to the physical properties of oil and the manufacturing process of pellets. The following difficulties might arise:

Oil Leakage: Oil tends to leak or migrate out of the pellets, especially if the pellet is not properly formulated or processed. This can result in reduced nutritional content in the pellets and create handling and storage issues. To address this, feed manufacturers often use binders or emulsifiers to help retain the oil within the pellet.

Pellet Durability: Adding oil to pellet formulations can affect the pellet's durability and stability. The presence of oil can make the pellets more susceptible to breakage or crumbling during transportation, storage, or feeding, leading to a loss of pellet integrity and reduced feed efficiency.

Processing Challenges: Oil can impact the processing characteristics of the feed during pellet manufacturing. It can make the feed mixture more difficult to extrude, resulting in poor pellet quality or increased energy requirements during the production process. Adjustments to the manufacturing parameters may be necessary to optimize the incorporation of oil into the pellets.

Oxidation and Rancidity: Oils are prone to oxidation, especially when exposed to heat, light, and oxygen. This can lead to the development of rancid flavors, reduced nutritional quality, and potential health risks for the aquatic animal. Feed manufacturers may add antioxidants or use specific processing techniques to mitigate oxidation and extend the shelf life of the oil-containing pellets.

Pellet Size: Typically, the pellets are extruded to sizes over 1 mm. For the obtention of micro particles of feeds (for example 10 to 500 microns), the pellets are broken down into smaller particles, typically through grinding, and then sorted or separated based on size using a sieve. This process is highly inefficient with pellets formulated with fats and oils as these ingredients promotes agglomeration and tend to clog the sieves.

Overcoming these difficulties requires careful formulation and processing techniques. Feed manufacturers often conduct extensive research and development to optimize pellet formulations, use suitable binders and emulsifiers, adjust processing parameters, and incorporate antioxidants to ensure the successful inclusion of oil in pellet feeds.

However, it has surprisingly been found that these difficulties can be overcome or alleviated by using in the pelleting process one or more alkali metals salts of fatty acids or a composition comprising them, i.e. in a form allowing the formulation of a feed composition for aquatic animals with reduced level of liquid oil inclusion, even without any liquid oil inclusion at all. By replacing all the liquid oil inclusion with alkali metal salts of fatty acids, it is possible to have a feed formulation made of only dry powdered ingredients, which simplify the logistic, production, storage, and shelf life of the feed compositions.

In the present invention, the feed contains one or more alkali metal salts of fatty acids, or is made from a composition comprising one or more alkali metal salts of fatty acids. In the latter case, the one or more alkali metal salts of fatty acids may undergo a partial conversion or reaction to other species during the production process of the feed, such as to form other species such as free fatty acids, or adducts or reaction products with other components of the feed, such as amino acids, due to the processing conditions (e.g. water and heat). This may result in a lower actual content of the alkali metal salts in the obtained feed as compared to the theoretical amount (defined as the amount of the one or more alkali metal salts of fatty acids that would be expected based on the content and amount of the one or more alkali metal salts of fatty acids in the starting materials used for producing the feed). The actual content ratio, defined as [(actual content of alkali metals salts of fatty acids in the feed/theoretical content of alkali metal salts of fatty acids calculated from the alkali metal salt of fatty acids content in the starting material)×100] is greater than 0%, such as 10% or more, 20% or more, 30% or more, or 40% or more, but is preferably 50% or more, 60% or more, 70% or more, 80% or more or 90% or more. The upper limit is 100%, which means that no conversion or reaction of the one or more alkali metal salts of fatty acids to other species occurs during the manufacturing process of the aquaculture feed.

In the following, the description of the nature and relative amount of the one or more alkali metal salts of fatty acids applies to both the final feed and a composition used for preparing the feed. Notably, the effects of the invention can also be obtained if the one or more alkali metal salts of fatty acids undergo partial conversion to other species in the manufacturing process. Still, it is a requirement of the present invention that the feed finally obtained comprises one or more alkali metal salts of fatty acids, even though their content may be reduced as compared to the theoretical amount that could be calculated based on the composition of the components prior to feed production.

The incorporation of alkali metal salts in the feed increases oxidation stability, in particular in the case of alkali metal salts of monounsaturated and polyunsaturated fatty acids, reduces oil leakage or bleaching and increases the hydrophilic characteristics of pellets or granules elaborated with such aquaculture feed, which allows the management of their floatability from naturally buoyant or slow sinking to sinking pellets. Naturally buoyant or slow sinking pellets are utilized for shrimp in the mysis and early postlarvae stages, which requires higher oil levels. Hoverer, high oil levels besides the problem of oil leakage mentioned above, have other disadvantages as well for the elaboration of small size pellets or powders, such as less than 100 μm in diameter or longest axis, which may be beneficial for the mysis and early postlarvae stages in shrimp, causing the grinding and sieving process of the pellets to be slow and inefficient due mainly to clogging the sieve mesh. To address this problem these pellets could be prepared with microalgae powder instead of oil, but this is a restrictive solution as microalgae oils have a complex process of production, reduced worldwide supply and relative high cost. Another option is the use of microencapsulated oils (for example with cyclodextrins), but as before, they have a complex process of production, reduced worldwide supply and relative high cost. In addition, both dry microalgae and microencapsulated oils have a relative low content of lipids, typically less than 40%, which requires at least the use of 2-3 times in weight of these ingredients, compared with the direct use of a fat or and oil, to achieve the desire lipid content in the pellet.

Dry forms of alkali metal salts are adequate, simple to produce, are easily available and are a less expensive substitute for microalgae powders or microencapsulated oils. They additionally have the surprising effect of increasing biomass production. When the feed comprising one or more alkali metal salts of fatty acid is derived from marine oils or by-products fractions produced by the Omega 3 Industry, it typically contains cholesterol as well which is an essential dietary nutrient for aquatic animals like salmon and shrimp.

The present invention thus contemplates any method or use of such alkali metal salts of fatty acids that results in ingestion of the alkali metal salts of fatty acids, or fatty acids derived from the alkali metal salts of fatty acids or other reaction products obtained therefrom, by the fish or crustacean. Such a method or use may utilize any form of the one or more alkali metal salts of fatty acids, e.g. as a component of a complete feed, as an additive feed, as a premix together with other components such as vitamins or minerals that is to be blended with other components prior to feeding, or in pure form.

In one embodiment of the present invention there is provided an aquaculture complete feed, typically in the form of powder or pellet, comprising one or more alkali metal salts of fatty acids, or prepared from a composition comprising one or more alkali metal salts of fatty acids. In other embodiments, the one or more alkali metal salts of fatty acids may be present in a premix together with other components or may be present solely. In one embodiment, the feed of the present invention thus comprises one or more alkali metal salts of fatty acids in an amount of 0.1 to 100% by weight, preferably from 0.5 to 40%.

In one embodiment, the feed, or the composition used for producing the feed, comprises, as the alkali metal salts of fatty acids, alkali metal salts of palmitic acid (PA), palmitoleic acid (POA), stearic acid (SA), oleic acid (OA), linoleic acid (LOA), alpha linolenic acid (LNA), arachidonic acid (ARA), eicosapentaenoic acid (EPA) and/or docosahexaenoic acid (DHA). This applies to all forms of the feed, e.g. also complete feeds, additive feeds or premixes.

In one embodiment, the one or more alkali metal salts of fatty acids comprised in the feed, or the composition used for producing the feed, comprise alkali metal salts of monounsaturated or polyunsaturated fatty acids, in particular C16-C30 monounsaturated or polyunsaturated fatty acids. The amount of salts of monounsaturated or polyunsaturated fatty acids may be 10% by weight or more, relative to all alkali metal salts of fatty acids forming alkali metal salts of fatty acids, such 20% by weight or more, 30% by weight or more, 40% by weight or more, 50% by weight or more, 60% by weight or more, 70% by weight or more, 80% by weight or more, 90% by weight or more, or 95% by weight or more, and the content thereof may be 100% by weight. This applies to all forms of the feed, e.g. also complete feeds, additive feeds or premixes.

In one embodiment, the one or more alkali metal salts of fatty acids comprised in the feed, or the composition used for producing the feed, comprise alkali metal salts of polyunsaturated fatty acids, in particular C16-C30 or polyunsaturated fatty acids. The amount of salts of polyunsaturated fatty acids may be 10% by weight or more, relative to all alkali metal salts of fatty acids forming alkali metal salts of fatty acids, such 20% by weight or more, 30% by weight or more, 40% by weight or more, 50% by weight or more, 60% by weight or more, 70% by weight or more, 80% by weight or more, 90% by weight or more, or 95% by weight or more, and the content thereof may be 100% by weight. This applies to all forms of the feed, e.g. also complete feeds, additive feeds or premixes.

In one embodiment, the one or more alkali metal salts of fatty acids comprised in the feed, or the composition used for producing the feed, comprise alkali metal salts of C20-C30 or polyunsaturated fatty acids. The amount of salts of the C20-C30 polyunsaturated fatty acids may be 10% by weight or more, relative to all alkali metal salts of fatty acids forming alkali metal salts of fatty acids, such 20% by weight or more, 30% by weight or more, 40% by weight or more, 50% by weight or more, 60% by weight or more, 70% by weight or more, 80% by weight or more, 90% by weight or more, or 95% by weight or more, and the content thereof may be 100% by weight. This applies to all forms of the feed, e.g. also complete feeds, additive feeds or premixes.

In another embodiment, the one or more alkali metal salts of fatty acids comprised in the feed, or the composition used for producing the feed, comprise alkali metal salts of C14-C20 monounsaturated or polyunsaturated fatty acids. The amount of salts of the C14-C20 monounsaturated or polyunsaturated fatty acids may be 10% by weight or more, relative to all alkali metal salts of fatty acids forming alkali metal salts of fatty acids, such 20% by weight or more, 30% by weight or more, 40% by weight or more, 50% by weight or more, 60% by weight or more, 70% by weight or more, 80% by weight or more, 90% by weight or more, or 95% by weight or more, and the content thereof may be 100% by weight.

In one embodiment, the feed may comprise cholesterol in addition to the one or more alkali metal salts of fatty acids. In one particular aspect of this embodiment, the content of cholesterol is 0.5% by weight or less, relative to the total weight of the feed. For additive feeds or premixes, the content of cholesterol may be higher than the feed, such as 1% or more relative to the additive feeds or premix, such 5% by weight or more, 10% by weight or more, 20% by weight or more, 30% by weight or more, 40% by weight or more or 50% by weight or more.

In one embodiment, the feed may comprise mono-glycerides in addition to the one or more alkali metal salts of fatty acids. In one particular aspect of this embodiment, the content of mono-glycerides is 2% by weight or less, relative to the total weight of the feed. For additive feeds or premixes, the content of mono-glycerides may be higher than the feed, such as 2% or more relative to the additive feeds or premix, such 5% by weight or more, 10% by weight or more or 20% by weight or more.

In one embodiment, the fatty acids of the alkali metal salts of fatty acids comprised in the feed, or in the composition used for producing the feed, derive from a marine oil. In this embodiment, the fatty acid forming the alkali metal salts of fatty acids comprised in the feed preferably comprise at least three fatty acids selected from palmitic acid, palmitoleic acid, stearic acid, oleic acid, linoleic acid, alpha linolenic acid, arachidonic acid, eicosapentaenoic acid and docosahexaenoic acid.

In an embodiment of the invention, the one or more alkali metal salts of fatty acids comprise in weight % of all alkali metals salts of fatty acids, palmitic acid (PA) between 0.1-80%, palmitoleic acid (POA) between 0.1-50%, stearic acid (SA) between 0.1-50%, oleic acid (OA) between 0.1-80%, linoleic acid (LOA) between 0.1-80%, alpha linolenic acid (LNA) between 0.1-80%, arachidonic acid (ARA) between 0.1-20%, eicosapentaenoic acid (EPA) between 0.1-60%, docosahexaenoic acid (DHA) between 0.1-60% and between 1-25% of one or more alkali metal salts of a fatty acid selected from the group consisting of the fatty acids C14:0, C20:0, C22:0, C24:0, C26:0, C18:1 n-7, C20:1 n-9, C22:1 n-9, C22:1 n-11, C24:1 n-11, C18:4 n-3, C20:2 n-6, C20:4 n-3, C21:5: n-3, C22:5 n-6, C22:5 n-3, C24:4 n-3, C24:5 n-3, C24:6 n-3, C26:4 n-3, C26:5 n-3, C26:6 n-3, C26:7 n-3, C28:4 n-3, C28:5 n-3, C28:6 n-3, C28:7 n-3, C28:8 n-3, C30:5 n-3 and C30:6 n-3.

In an embodiment of the invention the one or more alkali metals salts of fatty acids comprise in weight % of all alkali metals salts of fatty acids in a feed palmitic acid (PA) between 0.1-80%, palmitoleic acid (POA) between 0.1-25%, stearic acid (SA) between 0.1-50%, oleic acid (OA) between 1-80%, linoleic acid (LOA) between 1-80% and alpha linolenic acid (LNA) between 1-80% and at least one alkali metal salt of a fatty acid selected from the group consisting of the fatty acids C14:0, C20:0, C22:0, C24:0, C26:0, C20:1 n-9, C22:1 n-11, C22:1n-9.

In an embodiment of the invention the alkali metal salts of fatty acids in the aquaculture feed for feeding aquatic animals is obtained from marine oils and comprise alkali metal salts of palmitic acid, palmitoleic acid, stearic acid, oleic acid, linoleic acid, alpha linolenic acid, arachidonic acid, eicosapentaenoic acid and docosahexaenoic acid.

In an embodiment of the invention the alkali metal salts of fatty acids in the aquaculture feed or the composition used for producing the feed, does not contain neither eicosapentaenoic acid and/or docosahexaenoic acid and is obtained from vegetable oils, like linseed oil, and comprise alkali metal salts of palmitic acid, palmitoleic acid, stearic acid, oleic acid, linoleic acid, and alpha linolenic acid.

In an embodiment of the invention the alkali metal salts of fatty acids in the aquaculture feed for feeding aquatic animals is obtained from mixtures of one or more vegetable oils (such as linseed oil) and one or more marine oils or marine oil processed by-product, such as the light fraction or heavy fraction.

In an embodiment of the invention the alkali metal salts of fatty acids in the aquaculture feed for feeding aquatic animals is obtained from marine oil processed by-product, and further comprises cholesterol in an amount from 0.5 to 40 parts by weight, preferably from 1 to 20 parts by weight, relative to 100 parts by weight of the one or more alkali metal salts of fatty acids.

The description above applies to all feeds of the present invention, including complete feeds, additive feeds and premixes. These can be differentiated as follows:

### Complete Feed

In an embodiment of the present invention, the feed comprising one or more alkali metal salts of fatty acids is a complete feed. In this case, the feed comprises in addition to the one or more alkali metal salts of fatty acids other components, in particular one of and preferably both of carbohydrates and proteins. In addition, other components may optionally be present, such as lipids other than the one or more alkali metal salts of fatty acids, minerals, and vitamins. Also, pharmaceutical agents such as antibiotics and auxiliaries such as binders, antioxidants or preservatives may be present.

The content of the one or more alkali metal salts of fatty acids in the complete feed is not particularly limited, but is typically 40% by weight or less, e.g., 35% by weight or less, 30% by weight or less, or 25% by weight or less, relative to the total weight of the complete feed. In order to make the most benefit of the findings of the present invention, the content of the one or more alkali metal salts of fatty acids in the complete feed is preferably 0.1% by weight or more, such as 0.5% by weight or more, or 1% by weight or more, or 2% by weight or more, or 3% by weight or more, or 4% by weight or more, or 5% by weight or more, or 6% by weight or more, or 7% by weight or more, e.g. 8% by weight or more.

In an embodiment of the invention the alkali metal salts of fatty acids replace the fat and oil content of a standard aquaculture feed (typically having a total fat and oil content of between 2 and 40% by weight) by between 1 and 100%, preferably by between 25 and 100%, most preferably by between 50 and 100%, and here the feed preferably comprises at least three alkali metals salts of fatty acids selected from palmitic acid (PA), palmitoleic acid (POA), stearic acid (SA), oleic acid (OA), linoleic acid (LOA), alpha linolenic acid (LNA), arachidonic acid (ARA), eicosapentaenoic acid (EPA) and docosahexaenoic acid (DHA).

In an embodiment of the invention the content of alkali metal salts of fatty acids in the feed is higher than the standard percentage of fat or oils of a standard aquaculture feed by between 50% and 300%, preferably by between 100 and 200%, most preferably by between 100 and 175%, and the composition comprise at least three alkali metal salts selected from alkali metal salts of palmitic acid (PA), palmitoleic acid (POA), stearic acid (SA), oleic acid (OA), linoleic acid (LOA), alpha linolenic acid (LNA), arachidonic acid (ARA), eicosapentaenoic acid (EPA) and docosahexaenoic acid (DHA). The formulation of higher concentrations of alkali metal salts of fatty acids compared to the standards formulations with fats and oils in standard aquaculture feed composition can be achieved by adjusting the ingredient formulation by reducing or eliminating the fat or oils and/or reducing the concentration of carbohydrates. This ensures that the protein content in the feed remains unchanged even with higher concentrations of alkali metal salts of fatty acids.

The alkali metal of the one or more alkali metal salts of fatty acids is preferably selected from sodium, potassium, and mixtures thereof. The relative ratio of sodium and potassium salts can be adjusted depending on the nutritional demand of the fish or the crustacean. Sodium content in the feed can be adjusted to balance the sodium input of the sodium salt of fatty acids.

### Additive Feed

In one embodiment of the present invention, the feed comprising, or being obtained from a composition comprising, one or more alkali metal salts of fatty acids is an additive feed. An additive feed is fed in addition to a feed providing the majority of energy to the fish or crustaceans, so that additional components besides the one or more alkali metal salts of fatty acids are not necessary, but these are not excluded. Such additional components may e.g. be selected from vitamins and minerals, cholesterol, lecithin and combinations thereof.

In the additive feed of the present invention, the content of the one or more alkali metal salts of fatty acids can be set higher, as the fish or crustaceans also obtain other feeds. Thus, in one embodiment the total content of the one or more alkali metal salts of fatty acids can be set in the range from 20 to 100% by weight, relative to the total weight of the additive feed. The lower limit can also be 30, 40, 50, 60 or 70% by weight, and the upper limit can be less than 100%, e.g. 95% by weight, 90% by weight or 80% by weight, relative to the total weight of the additive feed, the remainder typically being formed by vitamins, minerals, cholesterol, lecithin and other micronutrients, and optionally technical auxiliaries such as drying agents, binders, emulsifiers, antioxidants, and coloring agents.

In the method of the present invention, the additive feed is directly fed to the fish or crustaceans in addition to a feed providing the majority of energy to the fish or crustaceans. The feeds can be fed simultaneously or at different points in time, in the same or in different administration frequencies.

### Premix

A premix may have the same features and composition as the additive feed, yet is used not for directly feeding the feed to the fish or crustaceans, but is used for productions of a complete feed by mixing with other required or desired components. Formulating the one or more alkali metal salts of fatty acids to a premix before compounding with other components to form a complete feed allows the use of the alkali metal salts of fatty acids as matrix or carrier for other micronutrients, vitamins and minerals.

In an embodiment of the invention, the alkali metal salts are used in the formulation of feed premixes for animal feeds, especially aquaculture feed premixes. The exact formulation and quantities of the components in a premix can vary significantly based on the nutritional needs of the animal being farmed, which are influenced by factors such as species, life stage, environmental conditions, and the formulation of the base feed. The premix can be elaborated by mixing the powder alkali metal salts of fatty acids composition with vitamins, minerals, cholesterol, amino acids, lecithin, enzymes, antioxidants, and other ingredients like immunostimulants, growth promoters, attractants.

### Method for Feeding a Crustacean or Fish

In one aspect, the present invention relates to method for feeding a crustacean or fish in a hatchery or farm of the crustacean or fish, the method comprising feeding the fish or crustacean with a feed comprising, or being made from a composition comprising, one or more alkali metal salts of fatty acids. Here, the description above in respect of the feed in general and the additive and complete feed apply analogously.

The feeding may be effected over a portion or period of the lifetime of the fish or crustaceans, or may be performed for the entire life time.

Preferably, the feeding is performed in the early life stages starting from larvae, as then the benefits of increased biomass production efficiency relative to a feed not containing one or more alkali metal salts of fatty acids can be most remarkably achieved. Here, the early life stage can be defined as the first 120 days after hatching, such as the first 90 days after hatching, e.g. the first 60 days or 45 days after hatching, or only the first 30 or 15 days after hatching.

The administration frequency of the feeding of the present invention is not particularly limited, and the administration can be conducted continuously or intermittently. The administration can be performed by manual operation or can be effected automatically, e.g. by an automatic feeding system that is either controlled by a human operator or which provided the feed according to a pre-programmed administration scheme (e.g. once every 2 to 6 hours). Preferably the feeding is performed continuously or at least once daily in order to gain the maximum benefit of the findings of the present invention. The feeding frequency and time can be adjusted to the day-night cycle of the fish or crustacean, such as 3-5 times, e.g. 4 times, during the daylight period and no or only one administration during the night period. The total amount of feed that is fed in one administration, or the amount fed over time, can be adjusted in accordance with the number of animals, their life stage, the desired increase in biomass production efficiency, etc. The duration for which the feed is administered can be set at will and has no upper limit, but in order to maximize the benefits of the present invention the feed is administered for preferably one day or more, such as 3 days or more or 5 days or more, such as 10 days or more or 15 days or more.

It is one interesting and surprising finding of the present invention that the produced fish or crustaceans have a fatty acid profile (in particular PUFA profile) that does not reflect the fatty acid profile of the feed. While the reasons for this are not fully understood, it is assumed that the fish and crustaceans, at least during their early life stages, are capable of prolonging the chain lengths of the fatty acids present in the feed of the present invention in form of the alkali metal salts of fatty acids. The present invention thus also allows maximizing the PUFA production by converting natural sources that are considered of lower values (e.g. C18 PUFAs) to the desired compounds (such as EPA and DHA). Thus, the findings of the present invention allow obtaining valuable materials from a source material that is generally considered as waste in an enriched omega 3 composition production process, such as in a process for producing enriched compositions of omega 3 acids such as EPA and DHA.

Biomass production efficiency, meaning the total weight gain of living aquatic organisms cultivated in aquaculture systems within a specified period, can be calculated by several methods known to the skilled person. Survival of the aquatic animal during a period is measured as the percentage that survive through the specific period of the culture cycle. Determining the number of surviving can also be done through various methods known to the skilled person.

### Method for Producing a Feed

The present invention further provides a method for producing a feed for feeding a fish or crustacean as described above, which method comprises mixing one or more alkali metal salts of fatty acids or a composition comprising one or more alkali metal salts of fatty acids with one or more other compositions, said other compositions comprising one or more components selected from the group consisting of animal protein, plant protein, carbohydrates, vitamins, minerals, cholesterol, lecithin, or said other composition being a marine oil processed product, such as a product or byproduct from a process for producing EPA and DHA concentrates from marine oil, e.g. the heavy fraction.

In an embodiment of the invention, the method of preparation of a feed, such as in pellet or powder form, for feeding an aquatic animal is done by mixing the composition of alkali metals salts of fatty acids with the solid ingredients of the feed formulation and then the mixture is pelletized or extruded. The feed can be a complete feed or an additive feed, but can also be a premix.

In one embodiment, the method for producing a feed comprises one or more steps selected from heating, homogenizing, pelletizing, extruding, drying or packaging the material obtained from the mixing step.

In an embodiment of the invention, the method of preparation of a feed pellet or granulate for feeding an aquatic animal is done by mixing the composition of alkali metals salts of fatty acids with the solid ingredients of the feed formulation, then the mixture is pelletized, grounded, and sieved to collect different size granulates.

In an embodiment of the invention, the pellets or granulates are prepared with solid ingredients only. In general, the method of preparation of such pellets or granulates may be carried out by the following protocol:
Grinding the solid ingredients to a desired particle size.
Combining the grounded ingredients in a mixer to create a homogeneous blend.
Optionally adding a liquid ingredient, such as oils.
Optionally, subjecting the mixture to a conditioning process where it is heated and moisturized.
Feeding the conditioned mixture to a pellet mill or extruder, where it undergoes compression and shaping.
Optionally, cutting the resulting pellets to the desired length.
Optionally drying the pellets to reduce moisture content.
Optionally, coating the pellets with additional nutrients, attractants, or medications to enhance palatability and nutritional content.
If the aquaculture feed pellet is intended for small aquatic animal or aquatic larvae, the pellet may be ground and sieved to achieve a desired particle size distribution of the pellets and/or powder.

The alkali metals salts of fatty acids may be present in the grounded ingredients that are fed to the mixer. If the optional coating is provided, the alkali metals salts of fatty acids may alternatively or additionally be present in the coating.

The alkali metals salts of fatty acids may be derived from any source, and can be of plant or animal origin or mixtures thereof. The alkali metals salts of fatty acids may be derived from by products from the Omega 3 Industry or mixtures of products from the Omega 3 Industry with vegetable oils and or marine oils.

In one embodiment, the composition comprising one or more alkali metal salts of fatty acids used for producing the feed comprises at least three fatty acids selected from palmitic acid, palmitoleic acid, stearic acid, oleic acid, linoleic acid, alpha linolenic acid, arachidonic acid, eicosapentaenoic acid and docosahexaenoic acid, and optionally further contains cholesterol. Such compositions are typically obtained from byproducts (light or heave fraction) in the Omega 3 industry.

In one embodiment of the present invention, the fatty acids of the alkali metal salts of fatty acids, or the alkali metal salts of fatty acids, derive from marine oils. In one particular aspect of this embodiment, the fatty acids of the alkali metal salts of fatty acids, or the alkali metal salts of fatty acids, derive from a distillation process stream that is part of a process or producing compositions containing omega 3 fatty acids in enriched form from the Omega 3 Industry, e.g. a process as described in Breivik, Harald, Long-chain Omega-3 Specialty Oils, Chapter 4, The Oily Press, 2007 (see FIGS. 10 & 11). Here, marine oils, like fish oil, is typically subjected to High Vacuum Distillation to obtain a distillate light fraction by product comprising free fatty acids and cholesterol, and a residue stream of vacuum-refined fish oil, which is typically trans-esterified with ethanol to produce ethyl esters. The ethyl esters are then fractionated by molecular distillation, to yield among other fractions, a heavy fraction, comprising a mixture of glycerides, ethyl esters and cholesterol, rich in C22 fatty acid (DHA) esters and very long polyunsaturated fatty acid ethyl esters.

Where the alkali metal salts of fatty acids used for the present invention derive from a fraction of distillation process that is performed with fatty acid alkyl (methyl or ethyl) esters, these can be converted to the respective alkali metals salts by hydrolysis or saponification under alkaline conditions using an appropriate alkali metal base such as KOH or NaOH or a mixture of NaOH and KaOH, utilizing between 75 to 100% of the saponification number, preferably between 90 to 99% of the saponification number, which may then be removed e.g. by precipitation and/or solvent removal. This also leads to a mixture of water and alkanol (e.g. methanol or ethanol), which can be recycled to the initial stage of the hydrolysis step.

In a specific embodiment of the invention the alkali metal salts of fatty acids are thus obtained by saponifying an oil (a marine oil or a plant oil or an oil processed product, like the light fraction or heavy fraction by-product of the omega 3 industry, or its mixtures) with aqueous sodium or potassium hydroxide or a mixture of aqueous sodium and potassium, utilizing between 75 to 100% of the saponification number of the oil, preferably between 90 to 99% of the saponification number, at a temperature from 30 to 170° C., to form a saponified mixture, followed by evaporating water, glycerol and ethanol (the later if the oil comprises ethyl esters of fatty acids) from the saponified mixture, in an evaporator to obtain a residue stream comprising a dry fluid saponified mixture, the evaporator operating at the pressure between 500 to 1000 mbar and the temperature between 250 to 350° C., followed by feeding the residue stream to a spray cooling/chilling (or prilling) unit or a drum or belt cooler or flaker unit to produce a mixture of solid alkali metal salts of fatty acid particles of different size comprising at least three alkali metal salts of fatty acids selected from alkali metal salts of palmitic acid, palmitoleic acid, stearic acid, oleic acid, linoleic acid, alpha linolenic acid, arachidonic acid, eicosapentaenoic acid and docosahexaenoic acid. The mixture of alkali metal salt particles can be milled and sieved to separate it into different size fractions or used as such. Preferred evaporators are short path evaporators and thin film evaporators.

In an specific embodiment of the invention the alkali metal salts of fatty acids are thus obtained by saponifying an oil (a marine oil or a plant oil or an oil processed product, like the light fraction or heavy fraction by-product of the omega 3 industry, or its mixtures) with aqueous sodium or potassium hydroxide or a mixture of aqueous sodium and potassium, utilizing between 75 to 100% of the saponification number of the oil, preferably between 90 to 98% of the saponification number, at a temperature from 30 to 170° C., to form a saponified mixture, followed by evaporating water and ethanol (the later if the oil comprises ethyl esters of fatty acids) from the saponified mixture to form a dry fluid saponified mixture in a first evaporator, operating at the pressure between 800 to 1200 mbar and the temperature of between 200 to 320° C., then evaporating glycerol from the dry fluid saponified mixture in a second evaporator, operating at the pressure between 100 to 800 mbar and the temperature 250 to 350° C., followed by feeding the residue from the second evaporator to a spray cooling/chilling (or prilling) unit or a drum or belt cooler or flaker unit to produce a mixture of solid alkali metal salts of fatty acid particles of different size comprising at least three alkali metal salts of fatty acids selected from alkali metal salts of palmitic acid, palmitoleic acid, stearic acid, oleic acid, linoleic acid, alpha linolenic acid, arachidonic acid, eicosapentaenoic acid and docosahexaenoic acid. The mixture of alkali metal salt particles can be milled and sieved to separate it into different size fractions or used as such. Preferred evaporators are short path evaporators and thin film evaporators.

In an embodiment of the invention the alkali metal salts of fatty acids are obtained by saponifying the light fraction (byproduct from the Omega 3 industry), comprising free fatty acids, and cholesterol, with aqueous sodium or potassium hydroxide or a mixture of aqueous sodium and potassium, utilizing between 75 to 100% of the saponification number of the light fraction, preferably between 90 to 98% of the saponification number, at a temperature from 30 to 170° C. to form a saponified mixture, followed by removing water and ethanol from the saponified mixture to produce a solid mixture comprising at least three alkali metal salts selected from alkali metal salts of palmitic acid, palmitoleic acid, stearic acid, oleic acid, linoleic acid, alpha linolenic acid, arachidonic acid, eicosapentaenoic acid and docosahexaenoic acid, and also comprising cholesterol. The mixture can be milled and sieved to separate it into different size fractions or used as such. Water and Ethanol is preferably removed by spray drying or by using one or two evaporators in series as described in the above two embodiments.

In an embodiment of the invention the alkali metal salts of fatty acids are made by saponifying the heavy fraction of the distillation process for the production of omega 3 concentrates (byproduct from the Omega 3 industry), comprising ethyl esters of fatty acids, mono, di and triglycerides of fatty acids (glycerides) and cholesterol, with aqueous sodium or potassium hydroxide or a mixture of aqueous sodium and potassium hydroxide, utilizing between 75 to 100% of the saponification number of the heavy fraction, preferably between 90 to 98% of the saponification number of the heavy fraction, at a temperature from 30 to 170° C., to form a saponified mixture, followed by evaporating water, glycerol and ethanol from the saponified mixture in an evaporator to obtain a residue stream comprising a dry fluid saponified mixture, the evaporator operating at the pressure between 500 to 1000 mbar and the temperature of between 250 to 350° C., followed by feeding the residue stream to a spray cooling/chilling (or prilling) unit or a drum or belt cooler or flaker unit to produce a mixture of solid alkali metal salts of fatty acid particles of different size comprising at least three alkali metal salts of fatty acids selected from alkali metal salts of palmitic acid, palmitoleic acid, stearic acid, oleic acid, linoleic acid, alpha linolenic acid, arachidonic acid, eicosapentaenoic acid and docosahexaenoic acid, and also comprising cholesterol. The mixture of alkali metal salt particles can be milled and sieved to separate it into different size fractions or used as such. Preferred evaporators are short path evaporators and thin film evaporators.

In an embodiment of the invention the alkali metal salts of fatty acids are made by saponifying the heavy fraction of the distillation process for the production of omega 3 concentrates (byproduct from the Omega 3 industry), comprising ethyl esters of fatty acids, mono, di and triglycerides of fatty acids (glycerides) and cholesterol, with aqueous sodium or potassium hydroxide or a mixture of aqueous sodium and potassium hydroxide, utilizing between 75 to 100% of the saponification number of the heavy fraction, preferably between 90 to 98% of the saponification number of the heavy fraction, at a temperature from 30 to 170° C., to form a saponified mixture, followed by evaporating water and ethanol from the saponified mixture to form a dry fluid saponified mixture, in a first evaporator operating at the pressure between 800 to 1200 mbar and the temperature of between 200 to 320° C., then evaporating glycerol from the saponified mixture free of water and ethanol, in a second evaporator operating at the pressure between 100 to 800 mbar and at a temperature from 250 to 350° C., followed by feeding the residue from the second evaporator to a spray cooling/chilling (or prilling) unit or a drum or belt cooler or flaker unit to produce a mixture of solid alkali metal salts of fatty acids comprising at least three alkali metal salts of fatty acids selected from the group consisting of palmitic acid, palmitoleic acid, stearic acid, oleic acid, linoleic acid, alpha linolenic acid, arachidonic acid, eicosapentaenoic acid and docosahexaenoic acid, and also comprising cholesterol. The mixture of solid alkali metal salts particles can be milled and sieved to separate it into different size fractions or used as such. Preferred evaporators are short path evaporators and thin film evaporators.

In an embodiment of the invention the alkali metal salts of fatty acids are made by saponifying a mixture of vegetable oil and the heavy fraction of the distillation process for the production of omega 3 concentrates (byproduct from the Omega 3 industry). The weight ratio of vegetable oil to the heavy fraction is from 10:1 to 1:1. The saponification is typically performed with aqueous sodium or potassium hydroxide or a mixture of aqueous sodium and potassium hydroxide, utilizing between 75 to 100% of the saponification number of the mixture of vegetable oil and the heavy fraction, preferably between 90 to 98% of the saponification number, at a temperature from 30 to 170° C. to form a saponified mixture, to form a saponified mixture, followed by evaporating water, glycerol and ethanol from the saponified mixture in an evaporator to obtain a residue stream comprising a dry fluid saponified mixture, the evaporator operating at the pressure between 500 to 1000 mbar and the temperature of between 250 to 350° C., followed by feeding the residue stream to a spray cooling/chilling (or prilling) unit or a drum or belt cooler or flaker unit to produce a mixture of solid alkali metal salts of fatty acid particles of different size comprising at least three alkali metal salts of fatty acids selected from alkali metal salts of palmitic acid, palmitoleic acid, stearic acid, oleic acid, linoleic acid, alpha linolenic acid, arachidonic acid, eicosapentaenoic acid and docosahexaenoic acid, and also comprising cholesterol. The mixture of alkali metal salt particles can be milled and sieved to separate it into different size fractions or used as such. Preferred evaporators are short path evaporators and thin film evaporators.

In an embodiment of the invention the alkali metal salts of fatty acids are made by saponifying a mixture of vegetable oil and the heavy fraction of the distillation process for the production of omega 3 concentrates (byproduct from the Omega 3 industry). The weight ratio of vegetable oil to the heavy fraction is from 10:1 to 1:1. The saponification is typically performed with aqueous sodium or potassium hydroxide or a mixture of aqueous sodium and potassium hydroxide, utilizing between 75 to 100% of the saponification number of the mixture of vegetable oil and the heavy fraction, preferably between 90 to 98% of the saponification number, at a temperature from 30 to 170° C. to form a saponified mixture, followed by evaporating water and ethanol from the saponified mixture to form a saponified mixture free of water and ethanol in a first evaporator operating at the pressure between 800 to 1200 mbar and the temperature of between 200 to 320° C., then evaporating glycerol from the saponified mixture free of water and ethanol in a second evaporator operating at the pressure between 100 to 800 mbar and at a temperature from 250 to 350° C., followed by feeding the residue from the second evaporator to a spray cooling/chilling (or prilling) unit or a drum or belt cooler or flaker unit to produce a mixture of solid alkali metal salts of fatty acids comprising at least three alkali metal salts of fatty acids selected from the group consisting of palmitic acid, palmitoleic acid, stearic acid, oleic acid, linoleic acid, alpha linolenic acid, arachidonic acid, eicosapentaenoic acid and docosahexaenoic acid, and also comprising cholesterol. The mixture of solid alkali metal salts particles can be milled and sieved to separate it into different size fractions or used as such. Preferred evaporators are short path evaporators and thin film evaporators.

In an embodiment of the invention the alkali metal salts of fatty acids are obtained by saponifying an oil (a marine oil or a plant oil or an oil processed product, like the light fraction or heavy fraction by-product of the omega 3 industry, or its mixtures) with aqueous sodium or potassium hydroxide or a mixture of aqueous sodium and potassium hydroxide, utilizing between 75 to 100% of the saponification number of the oil, preferably between 90 to 98% of the saponification number, at a temperature from 30 to 100° C., preferably between 40 to 80° C., to form a saponified mixture, followed by acidulation of the saponified mixture with an aqueous solution of an inorganic or organic acid like sulfuric acid, hydrochloric acid, citric acid and the like. The acidulated mixture is decanted or centrifugated and a free fatty acid composition is recovered from the light phase. The free fatty acids composition is neutralized with aqueous sodium or potassium hydroxide or a mixture of aqueous sodium and potassium, followed by evaporating the water from the neutralized mixture to produce a solid mixture comprising at least three alkali metal salts selected from alkali metal salt of fatty acids selected from the group consisting of palmitic acid, palmitoleic acid, stearic acid, oleic acid, linoleic acid, alpha linolenic acid, arachidonic acid, eicosapentaenoic acid and docosahexaenoic acid. The mixture can be milled and sieved to separate it into different size fractions or used as such. The evaporation is preferably done by spray drying.

### Method for Increasing the Concentration of Omega 3 Fatty Acid in a Fish or Crustacean

In an embodiment of the invention, the present invention provides a method for increasing the concentration of omega 3 fatty acids in an aquatic animal meat, the process comprising:
a) providing an aquatic animal in a hatchery or farm;
b) feeding said aquatic animal with a feed comprising alkali metals salts of fatty acids;
c) harvesting said aquatic animal wherein said animal has increased concentration of omega 3 fatty acids.

The feed is the same as described above. The aquatic animal may be a fish or crustacean. The feeding may be effected for a desired period of time, but preferably over at least once or several times daily over a period of at least one day, such as at least 2, 3 or 5 days, e.g. at least 10 days, or until the animal has reached its target growth.

In an embodiment of the invention, the method for increasing the concentration of omega 3 fatty acids in fish meat is done by a process of:
a) providing a fish in a hatchery or farm;
b) feeding said fish with a feed comprising alkali metals salts of fatty acids;
c) harvesting said fish.

The fish obtained by the method have in increased concentration of omega 3 fatty acids, in particular PUFAs, as compared to a fish that is obtained with a feed not containing alkali metal salts of fatty acids. The feeding may be effected for a desired period of time, but preferably over at least once or several times daily over a period of at least one day, such as at least 2, 3 or 5 days, e.g. at least 10 days, or until the animal has reached its target growth.

In another embodiment, the method for increasing the concentration of omega 3 fatty acids in shrimp comprises the steps of:
a) providing a shrimp in a hatchery or farm;
b) feeding said shrimp with a feed comprising alkali metals salts of fatty acids;
c) harvesting said shrimp.

The feeding may be effected for a desired period of time, but preferably over at least once or several times daily over a period of at least one day, such as at least 2, 3 or 5 days, e.g. at least 10 days, or until the shrimp has reached its target growth.

The shrimp obtained by the method have in increased concentration of omega 3 fatty acids, in particular PUFAs, as compared to a shrimp that is obtained with a feed not containing alkali metal salts of fatty acids.

### Examples

1. Production of a Composition Comprising Alkali Metal Salts of Fatty Acids from Tuna Oil.

10 kg of tuna oil was fed into a 20-liter stainless steel reactor equipped with agitation and jacket heating (manufactured by Pfaudler). The oil was heated to 80° C. under nitrogen atmosphere. 3.35 kg of a NaOH solution, produced by mixing 2.0 kg of water and 1.35 kg of NaOH, was fed into the reactor under agitation. Then the reactor was sealed under nitrogen atmosphere and the mixture was heated to 110° C. for 15 minutes to produce a saponified mixture.

The saponified mixture was fed to a two stage in series short paths evaporators (manufactured by Pfaudler), of 0.2 and 0.1 m2 respectively. The first short path was fed at 5 kg/h and operated at 270° C. and atmospheric pressure. A distillate stream was produced comprising mainly water. The residue stream was fed continuously to the second short path, operated at 290° C. and 200 mbar. The distillate stream from the second evaporator comprised mainly glycerol. The residue of the second short path evaporator was fed continuously to a drum flaker, refrigerated with water, to recover solid flakes of alkali metal salt of fatty acids.

The flakes of alkali metal salts of fatty acids were milled in a knife mill and then sieved through a sieve of Mesh #100 (149 microns).

The composition of the starting Tuna oil and the final alkali metal salt of fatty acid composition is shown in table 1:

TABLE 1

| | | Alkali metal salts of |
|---|---|---|
| | | fatty acids composition |
| | Tuna Oil | from Tuna Oil |
| Acid Value, mg KOH/g | 0.68 | n.d. |
| Free Alkalinity, mg NaOH/g | n.d. | n.d. |
| Total Alkalinity, mg NaOH/g | n.d. | 132.41 |
| TOTOX Value | 18.71 | 3.02 |
| Cholesterol, mg/g | 7.19 | 7.50 |
| Myristic acid, % | 6.44 | 6.93 |
| Palmitic acid, % | 19.19 | 21.04 |
| Palmitoleic acid, % | 8.56 | 8.85 |
| Stearic acid, % | 6.46 | 6.91 |
| Oleic acid, % | 20.18 | 21.72 |
| Linoleic acid, % | 3.26 | 3.42 |
| α-Linoleic acid, % | 0.80 | 0.81 |
| Stearidonic acid, % | 0.13 | 0.14 |
| Eicosenoic acid, % | 1.76 | 1.89 |
| Erucic acid, % | 1.42 | 1.44 |
| Arachidonic acid, % | 0.21 | 0.23 |
| Eicosapentaenoic acid, % | 7.54 | 7.57 |
| Docosapentaenoic acid, % | 0.13 | 0.14 |
| Docosahexaenoic acid, % | 13.07 | 13.65 |
| Total n3 PUFAs, % | 21.89 | 22.54 |

Note:
Fatty acid analysis performed based on AOAC Method 991.39. For the analysis of the alkali metal salts of fatty acids composition, a sample was first neutralized with an aqueous solution of HCl, then the free fatty acids were recovered by hexane extraction, and then the hexane extract was evaporated in a rotavapor under vacuum. The dried recovered fatty acids were then analyzed by the AOAC method 991.39. N.D.: Not detected (absent or below limit of detection).

The solid particles of the alkali metal salts of fatty acids composition are free of glycerin, freely flows, do not tend to agglomerate, and were efficiently sieved through Mesh #100. If required, the powdery alkali metal salts of fatty acids composition can be mixed with anti-caking agents like silicon dioxide, calcium silicates, magnesium stearates and others. Typically, 0.1 to 2% of anti-caking agents can be used.

The powder of the alkali metal salts of fatty acids composition had a reduced TOTOX value than the starting tuna oil and had a similar fatty acid profile. No fatty acid losses were detected due to the process of making the powdery alkali metal salts of fatty acids composition. This is mainly due to the short residence time of the short path evaporators, which is less than one minute, therefore the high temperature expose of the alkali metal salts of fatty acids composition is minimum, allowing a remarkable stability of the alkali metal salts of fatty acids composition. The process is highly efficient to refine oils with high TOTOX to yield an alkali metal salts of fatty acids composition with low oxidation parameters, typically with a TOTOX number below 10.

The powdery alkali metal salts of fatty acids composition can be mixed with an antioxidant like BHT, BHA to improve oxidative shelf life. Typically, 0.002 to 0.2% of BHA, BHT can be used.

2. Production of a Composition Comprising Alkali Metal Salts of Fatty Acids from the Heavy Fraction of the Omega 3 Industry.

In the Omega 3 Industry for the production of concentrated EPA and DHA, crude fish oils or mixtures of crude fish oils and/or refined fish oils or mixtures of refined fish oils, are typically trans-esterified with ethanol and then concentrated by high vacuum short path distillation. The process yields one or more heavy byproduct fractions, or heavy fraction, which comprises ethyl esters of fatty acids, glycerides of fatty acids (mono, di and tri glycerides) and cholesterol. Any fraction from the high vacuum short path distillation step is suitable to produce alkali metal salts of fatty acids composition of the present invention, however the heavy fraction is especially useful due its high concentration of cholesterol and omega 3 fatty acids.

10 kg of a sample of heavy fraction produced from anchovy oil was processed in the same process equipment as disclosed in example 1. The heavy fraction was fed to the reactor and heated to 80° C. 3.0 kg of a NaOH solution, produced by mixing 2.0 kg of water and 1.0 kg of NaOH, was fed into the reactor under agitation. Then the reactor was sealed under nitrogen atmosphere, and the mixture was heated to 115° C. for 15 minutes to produce a saponified mixture.

The saponified mixture was fed to the two stages in series short paths evaporators described in example 1. The first short path was fed at 5 kg/h and operated at 250° C. and atmospheric pressure. A distillate stream was produced comprising mainly water and ethanol. The residue stream was fed continuously to the second short path, operated at 270° C. and 250 mbar. The residue of the second short path evaporator was fed continuously to a drum flaker cooled with water to recover flakes of the alkali metal salts of fatty acids composition.

The flakes were milled in a knife mill and then sieved through a sieve of Mesh #100 (149 microns).

The composition of the starting heavy fraction material and the final alkali metal salts of fatty acids composition is shown in table 2:

TABLE 2

| | | Alkali metal salts of |
|---|---|---|
| | Heavy | fatty acids composition |
| | Fraction | from Heavy Fraction |
| Acid Value, mg KOH/g | 2.95 | n.d. |
| Free Alkalinity, mg NaOH/g | n.d. | n.d. |
| Total Alkalinity, mg NaOH/g | n.d. | 99.56 |
| TOTOX Value | 20.59 | 7.38 |
| Cholesterol, mg/g | 94.91 | 98.35 |
| Myristic acid, % | 0.26 | 0.31 |
| Palmitic acid, % | 2.21 | 2.46 |
| Palmitoleic acid, % | 0.48 | 0.55 |
| Stearic acid, % | 1.24 | 1.32 |
| Oleic acid, % | 0.76 | 0.77 |
| Linoleic acid, % | n.d. | n.d. |
| α-Linoleic acid, % | n.d. | n.d. |
| Stearidonic acid, % | 0.28 | 0.28 |
| Eicosenoic acid, % | n.d. | n.d. |
| Erucic acid, % | 1.17 | 1.26 |
| Arachidonic acid, % | 0.46 | 0.48 |
| Eicosapentaenoic acid, % | 6.9 | 7.38 |
| Docosapentaenoic acid, % | 7.29 | 7.87 |
| Docosahexaenoic acid, % | 27.81 | 29.02 |
| Very Long Chain PUFAs | 6.9 | 7.28 |
| (C24:5, C24:6, C26:4, C26:5, C26:6, | | |
| C28:4, C28:5, C28:6, C28:7, C28:8, | | |
| C30:5, C30:6) | | |
| Total n3 PUFAs, % | 49.18 | 51.83 |

The analysis was performed in the manner as indicated below Table 1.

The solid particles of alkali metal salts of fatty acids composition are free of glycerin, free of ethyl esters of fatty acids, freely flows, do not tend to agglomerate, and where efficiently sieved through Mesh #100.

The powdery alkali metal salts of fatty acids composition obtained from the heavy fraction is particularly useful in the formulation of feed premixed for aquaculture feeds due its high content of omega 3 and cholesterol, typically over 30% of omega 3 fatty acids and over 3% of cholesterol. The premix can be formulated by mixing the powdery alkali metal salts of fatty acids composition with vitamins (A, K, D, C, E), minerals, lecithin. Dry lecithin can be used, allowing a premix mixture to be made of only powder ingredients.

3. Production of a Alkali Metal Salts of Fatty Acids Composition from Linseed Oil.

In a 10-liter glass lined reactor equipped with agitation, jacketed with hot oil heating supply (manufactured by Buchi), 2 kg of linseed oil was charged and mixed with 3 kg of a solution made with 2.740 kg of water and 260 grams of the sodium hydroxide. The reactor was heated under agitation at 80° C. for 45 minutes and then cooled to 50° C. Then the saponified mixture was acidulated with 2 kg of a sulfuric acid solution made with 1.650 kg of water and 350 g of sulfuric acid. A two-phase mixture was recovered and decanted. The light phase composed of mainly free fatty acids was separated and washed with hot water. The acid value of the washed light phase was 184.01 with 98.3% of nonvolatile matter.

1 kilogram of the above washed light phase was charged to a 1-gallon reactor. 100 mg of BHA were added, and the mixture was heated to 80° C. Then, 1.13 kg of a NaOH solution was added under agitation. The latter was produced by mixing 1.0 kg of water and 0.13 kg of NaOH. After adding the NaOH solution, the mixture was stirred for 15 minutes at 80° C. to obtain a neutralized mixture. The neutralized mixture was then dried in a glass laboratory spray drier (manufactured by Buchi, model B-190). The drying process was done at a feed rate of 5 ml/min with an air flow at 170° C. The dried sodium salts of fatty acids composition from linseed oil were recovered as a free-flowing powder of an average 710-micron size.

The dried sodium salts of fatty acids composition from linseed oil were milled in a knife mill and then sieved through a sieve of Mesh #100 (149 microns).

The analysis of the starting linseed oil and final composition after sieving is shown in table 3.

TABLE 3

| | | Alkali metal salts of |
|---|---|---|
| | Linseed | fatty acids composition |
| | Oil | from Linseed Oil |
| Acid Value, mg KOH/g | 0.78 | n.d. |
| Free Alkalinity, mg NaOH/g | n.d. | n.d. |
| Total Alkalinity, mg NaOH/g | n.d. | 133.69 |
| TOTOX Value | 9.21 | 1.74 |
| Cholesterol, mg/g | n.d. | n.d. |
| Myristic acid, % | 0.09 | 0.08 |
| Palmitic acid, % | 5.42 | 5.51 |
| Palmitoleic acid, % | 0.06 | 0.07 |
| Stearic acid, % | 4.08 | 4.1 |
| Oleic acid, % | 19.43 | 20.21 |
| Linoleic acid, % | 17.15 | 17.87 |
| α-Linoleic acid, % | 48.79 | 50.21 |
| Stearidonic acid, % | n.d. | n.d. |
| Eicosenoic acid, % | 0.1 | 0.1 |
| Erucic acid, % | n.d. | n.d. |
| Arachidonic acid, % | n.d. | n.d. |
| Eicosapentaenoic acid, % | n.d. | n.d. |
| Docosapentaenoic acid, % | n.d. | n.d. |
| Docosahexaenoic acid, % | n.d. | n.d. |
| Total n3 PUFAs, % | 48.79 | 50.21 |

The analysis was performed in the manner as indicated below Table 1.

The solid particles of the sodium alkali metal salts of fatty acids composition are free of glycerin, freely flow, do not tend to agglomerate, and where efficiently sieved through Mesh #100.

4. Production of a Composition of Alkali Metal Salts of Fatty Acids from the Light Fraction of the Omega 3 Industry.

In the Omega 3 Industry, crude fish oils or mixtures of crude fish oils, are typically refined by high vacuum distillation (physical refining), which yields to a distillate byproduct fraction, or light fraction, which comprises free fatty acids, cholesterol and in some cases ethyl ester of fatty acids.

10 kg of a light fraction sample produced from a mixture of sardine oil and mackerel oil was processed in the same process equipment as disclosed in example 1. The light fraction was fed to the reactor and heated to 80° C. 5.0 kg of a alkaline solution, produced by mixing 3.8 kg of water with 1.160 grams of NaOH and 40 grams of KOH, was fed into the reactor under agitation. Then the reactor was sealed under nitrogen atmosphere and the mixture was heated to 80° C. for 45 minutes to produce a saponified mixture.

The saponified mixture was fed to the two stages in series short paths evaporators described in example 1. The first short path was fed at 5 kg/h, operated at 260° C. and atmospheric pressure. A distillate stream was produced comprising mainly water and ethanol. The residue stream was fed continuously to the second short path, operated at 270° C. and 210 mbar. The residue stream of the second short path evaporator was fed continuously to a drum flaker cooled with water to recover flakes of alkali metal salts of fatty acids composition.

The flakes of alkali metal salts of fatty acid were milled in a knife mill and then sieved through a sieve of Mesh #100 (149 microns).

The composition of the starting light fraction material and the final composition is shown in table 4:

TABLE 4

| | | Alkali metal salts of |
|---|---|---|
| | Light | fatty acids composition |
| | Fraction | from Light Fraction |
| Acid Value, mg KOH/g | 105.03 | n.d. |
| Free Alkalinity, mg NaOH/g | n.d. | n.d. |
| Total Alkalinity, mg NaOH/g | n.d. | 122.31 |
| TOTOX Value | 56.31 | 9.31 |
| Cholesterol, mg/g | 69.82 | 70.73 |
| Myristic acid, % | 5.10 | 5.43 |
| Palmitic acid, % | 9.04 | 9.41 |
| Palmitoleic acid, % | 4.24 | 4.38 |
| Stearic acid, % | 2.96 | 2.99 |
| Oleic acid, % | 6.15 | 6.28 |
| Linoleic acid, % | 0.60 | 0.62 |
| α-Linoleic acid, % | 0.36 | 0.37 |
| Stearidonic acid, % | 1.58 | 1.68 |
| Eicosenoic acid, % | 0.58 | 0.62 |
| Erucic acid, % | 0.00 | 0.0 |
| Arachidonic acid, % | 1.73 | 1.81 |
| Eicosapentaenoic acid, % | 13.16 | 13.65 |
| Docosapentaenoic acid, % | 2.33 | 2.42 |
| Docosahexaenoic acid, % | 20.33 | 21.29 |
| Total n3 PUFAs, % | 37.25 | 37.78 |

The analysis was performed in the same manner as indicated below Table 1.

Typically, the light fraction byproduct of the omega 3 industry comprises a high level of Persistent Organic Pollutants (POP), like dioxins, furans, PCBs and PAH.

Table 5 discloses the POP concentration of the light fraction and the alkali metal salts of fatty acids composition produced from the same:

TABLE 5

| | | Alkali metal salts of |
|---|---|---|
| | Light | fatty acids composition |
| | Fraction | from Light Fraction |
| PCB 209 Congener include | 71.1 | 4.26 |
| (IUPAC No 28, 52, 101, | | |
| 118, 138, 153, 180), ppb | | |
| Dioxin and Furans | 0.922 | 0.349 |
| (WHO-PCDD/F-TEQ), ppt | | |
| Dioxin & Furans and Dioxin like | 8.53 | 0.723 |
| PCBs (WHO-PCDD/F-PCB TEQ), ppt | | |
| Benzo(a)pyrene, ppb | 21.6 | 1.7 |
| Sum 4 PAH, ppb | 73.2 | 3.1 |

As can be seen above, the process of manufacturing sodium salts of fatty acid in high vacuum short path evaporators significantly reduces the presence of POPs.

5. Production of a Alkali Metal Salts of Fatty Acids Composition from Linseed Oil and the Heavy Fraction of the Omega 3 Industry.

A mixture of 3 kg of heavy fraction (same as used in Example 2) and 7 kg of linseed oil (same as used in Example 3) was processed in the same process equipment as disclosed in example 1. The mixture was fed to the reactor and heated to 80° C. 4.5 kg of a NaOH solution, produced by mixing 3.5 kg of water and 1.150 grams of NaOH, was fed into the reactor under agitation. Then the reactor was sealed under nitrogen atmosphere, and the mixture was heated to 85° C. for 50 minutes to produce a saponified mixture.

The saponified mixture was fed only to the first stage of the two short paths evaporator. The first short path was fed at 5 kg/h and operated at 305° C. and atmospheric pressure. A distillate stream was produced comprising mainly water and glycerol. The residue of the short path evaporator was fed continuously to a priller tower, equipped with a nozzle model 1/4M-316SS1 from Spraying System Co. and cooled with countercurrent air at 20° C., to recover prills of alkali metal salts of fatty acids composition. The prills were recovered as a free-flowing powder of an average 930-micron size.

The prills were milled in a knife mill and then sieved through a sieve of Mesh #100 (149 microns).

The analysis of the final composition after sieving is shown in table 6.

TABLE 6

| | Alkali metal salts of |
|---|---|
| | fatty acids composition |
| | from Linseed Oil and |
| | heavy byproduct fraction |
| Acid Value, mg KOH/g | n.d. |
| Free Alkalinity, mg NaOH/g | n.d. |
| Total Alkalinity, mg NaOH/g | 111.27 |
| TOTOX Value | 4.21 |
| Cholesterol, mg/g | 31.92 |
| Myristic acid, % | 0.16 |
| Palmitic acid, % | 4.45 |
| Palmitoleic acid, % | 0.21 |
| Stearic acid, % | 3.24 |
| Oleic acid, % | 13.2 |
| Linoleic acid, % | 11.53 |
| α-Linoleic acid, % | 32.68 |
| Stearidonic acid, % | 0.11 |
| Eicosenoic acid, % | 0.08 |
| Erucic acid, % | 0.38 |
| Arachidonic acid, % | 0.15 |
| Eicosapentaenoic acid, % | 2.34 |
| Docosapentaenoic acid, % | 2.44 |
| Docosahexaenoic acid, % | 9.33 |
| Very Long Chain PUFAs | 2.24 |
| (C24:5, C24:6, C26:4, C26:5, C26:6, C28:4, | |
| C28:5, C28:6, C28:7, C28:8, C30:5, C30:6 | |
| Total n3 PUFAs, % | 49.14 |

The analysis was performed in the manner as indicated below Table 1.

The solid particles of the alkali metal salts of fatty acids composition are free of glycerin, free of ethyl esters of fatty acids, freely flow, do not tend to agglomerate, and where efficiently sieved through Mesh #100. No degradation of fatty acids was detected.

### 6. Production of Shrimp Larvae Feeds.

The ingredients of table 7 were grinded and sieved below 300 micrometers. The sieved ingredients were mixed and preconditioned with steam (>90° C.) and post conditioned for 20 minutes (>90° C.), then were extruded through a 1.5 mm die.

Subsequently the pellets were grounded and sieved into 4 fractions:

$$\begin{matrix}Fraction 1 : & < 50 micron & ( for Mysis 2 ) \\ Fraction 2 : & 50 - 100 micron & ( for Mysis 3 till PL 2 ) \\ Fraction 3 : & 100 - 200 micron & ( for PL 3 - PL 5 ) \\ Fraction 4 : & 200 - 300 micron & ( for PL 6 - PL 15 )\end{matrix}$$

TABLE 7

| | FEED A | FEED B | FEED C | FEED D | FEED E |
|---|---|---|---|---|---|
| Marine Protein | 48.5 | 48.5 | 48.5 | 48.5 | 48.5 |
| (fish meal, krill meal, squid meal) | | | | | |
| Vegetal Protein | 5.0 | 5.0 | 5.0 | 5.0 | 5.0 |
| (Canola Meal, Wheat gluten, algae meal) | | | | | |
| Hydrolysates | 9.0 | 9.0 | 9.0 | 9.0 | 9.0 |
| Vegetal Carbohydrates | 25.5 | 25.7 | 22.8 | 25.5 | 25.9 |
| Micronutrients | 4.0 | 3.9 | 3.8 | 4.0 | 3.6 |
| (Vitamins, minerals, cholesterol) | | | | | |
| Lecithin | 2.0 | 2.0 | 2.0 | 2.0 | 2.0 |
| Tuna oil | 6.0 | 0 | 0 | 0 | 0 |
| (same batch as used in example 1) | | | | | |
| Alkali metal salts of fatty acids | 0 | 6.0 | 9.0 | 0 | 0 |
| composition from linseed oil and heavy | | | | | |
| fraction (as produced in Example 5) | | | | | |
| Alkali metal salts of fatty acids | 0 | 0 | 0 | 6.0 | 0 |
| composition from tuna oil (as | | | | | |
| produced in Example 1) | | | | | |
| Alkali metal salts of fatty acids | 0 | 0 | 0 | 0 | 6.0 |
| composition from light fraction (as | | | | | |
| produced in Example 4) | | | | | |

All ingredients in weight % based on the total weight of the feed.

All the Feeds of table 7 had a nominal Crude Protein content of 54%.

Feed A had a Crude Lipid Content of 11%. A 6% of Tuna Oil was used in the formulation. The Tuna Oil utilized was the same as utilized in example 1. This feed was used as the control group, representing a standard feed formulation for larvae shrimp, made with fish oil (tuna oil, triglyceride).

Feed D composition had 6% of the alkali metal salts of fatty acids composition from Tuna Oil as produced in example 1. No tuna oil was used in Feed D. The use of the dry powdery alkali metal salts of fatty acids composition for the replacement of oils was done directly, without the need to modify the original formulation composition or without the need to dilute the crude protein. In Feed D, 100% of the original oil of the standard formulation (Feed A) was replaced with the alkali metal salts of fatty acids composition.

Feed B composition had 6% of the alkali metal salts of fatty acids composition from linseed oil and the heavy fraction of the Omega 3 industry, as produced in example 5. No Tuna Oil was used in Feed B. In Feed B, 100% of the original oil of the standard formulation (Feed A) was replaced with the alkali metal salts of fatty acids composition.

Feed C formulation had 9% of the composition of alkali metal salts of fatty acids from linseed oil and the heavy fraction of the Omega 3 industry, as produced in example 5, 50% more than in Feed B. No tuna oil was used in Feed C. Feed C had 3% less of wheat flour than the other feeds to balance the extra 3% addition of alkali metal salts of fatty acids. The use of a higher content of lipids in the formulation in the form of alkali metal salts of fatty acids can be easily formulated by reducing the use of carbohydrates (wheat flour), without reducing the content of crude protein. In Feed C, 150% of the original oil of the standard formulation (Feed A) was replaced with the alkali metal salts of fatty acids composition.

Feed E composition had 4% of the alkali metal salts of fatty acids composition from the light fraction of the Omega 3 industry, as produced in example 2. No Tuna Oil was used in Feed E. In Feed E, 100% of the original oil of the standard formulation (Feed A) was replaced with the alkali metal salts of fatty acids composition.

All Feeds were formulated to have a cholesterol addition of 0.42% based on the feed. Due to the high cholesterol content in the alkali metal salts of fatty acids composition from the light fraction, no cholesterol addition was required in this Feed E (cholesterol from Lanolin, SF91%).

All the ingredients of the Feed formulations from B to E were available in powder form; therefore, the formulations were made only with solid ingredients, which facilitated and simplified the blending of the ingredients. Additionally, the sieving of Feeds B to E yields from 180 to 340% more product below 50 microns compared with Feed A, due to the stickiness property of the liquid Tuna Oil in feed A, causing particles to adhere to the sieve's surface and gradually blocking the openings.

### 7. Production of Shrimp Post Larvae Feeds.

The ingredients of table 8 were grinded and sieved below 300 micrometers. The sieved ingredients were mixed and preconditioned with steam (>90° C.) and post conditioned for 20 minutes (>90° C.), then were extruded through a 1.5 mm die.

TABLE 8

| | FEED F | FEED G | FEED H |
|---|---|---|---|
| Marine Protein | 26.0 | 26.0 | 26.0 |
| (fish meal, krill meal, squid meal) | | | |
| Vegetal Protein | 19.6 | 19.6 | 19.6 |
| (Canola meal, Wheat gluten, algae | | | |
| meal) | | | |
| Hydrolysates | 5.0 | 5.0 | 5.0 |
| Vegetal Carbohydrates | 42.4 | 42.4 | 42.4 |
| Micronutrients | 2.5 | 2.5 | 2.5 |
| (vitamins, minerals, cholesterol) | | | |
| Lecithin | 2.0 | 2.0 | 2.0 |
| Tuna oil | 2.5 | 0.0 | 0.0 |
| (same batch as used in example 1) | | | |
| Composition comprising alkali metal | 0.0 | 2.5 | 0.0 |
| salts of fatty acids from tuna oil | | | |
| (as produced in Example 1) | | | |
| Composition comprising alkali metal | 0.0 | 0.0 | 2.5 |
| salts of fatty acids from linseed | | | |
| oil (as produced in Example 3) | | | |

All ingredients in weight % based on the total weight of the feed.

All the Feeds of table 8 had a nominal Crude Protein content of 38%.

Feed F had a Crude Lipid Content of 8%. 2.5% of Tuna Oil was used into the formulation. The Tuna Oil utilized was the same as in Example 1. This group was used as the control group, representing a standard feed formulation for Post Larvae (PL) shrimp, made with fish oil (tuna oil, triglyceride).

Feed G composition had 2.5% of the alkali metal salts of fatty acids composition from Tuna Oil as produced in example 1. No Tuna Oil was used in Feed G. In Feed G, 100% of the original oil of the standard formulation (Feed F) was replaced by the alkali metal salts of fatty acids composition.

Feed H formulation had 2.5% of the alkali metal salts of fatty acids composition from Linseed Oil as produced in example 3. No Tuna Oil was used in Feed H. In Feed H, 100% of the original oil of the standard formulation (Feed F) was replaced with the alkali metal salts of fatty acids composition.

All the ingredients of the Feeds G and H were available in powder form; therefore, these two formulations were made only with solid ingredients, which facilitated and simplified the blending of the ingredients.

### 8. Production of Salmon Feeds.

Control Groups (FEED 1) and Experimental Diet (FEED 1l) were elaborated using the ingredients of table 9.1 & 9.2 respectively. All powder ingredients were mixed and grounded below 400 microns. In FEED II the alkali metal salts of fatty acids composition was added together with the powdered ingredients. The mixed ingredients were extruded in a twin-screw extruder through a 1.2 mm die. Granule diets (0.4-1 mm) were made by grinding and sieving. The diets were dried in a vibrating fluid bed dryer.

In the control diet the tuna oil was added by vacuum coating of the pellets and granulates (700 mbar). Instead, in the experimental diets the vacuum coating step was unnecessary as the alkali metal salts of fatty acids composition were added with all the powder ingredients. The use of solid particles of alkali metal salts of fatty acids composition simplify the process of production of pellets. All the diets were cooled and packed in sealed plastic buckets.

TABLE 9.1
FEED I (Control Diet)

| | Fry | Fingerling | Smolt |
|---|---|---|---|
| Animal Protein (fish meal, krill meal, | 62.5 | 55.1 | 45.4 |
| Poultry meal) | | | |
| Vegetal Protein (Soybean, Corn meal) | 0 | 15.0 | 22.0 |
| Hydrolysates | 11.0 | 0 | 3.0 |
| Vegetal Carbohydrates | 14.1 | 9.1 | 8.2 |
| Micronutrients (vitamins, minerals) | 2.0 | 2.0 | 2.0 |
| Tuna oil | 10.4 | 18.8 | 19.4 |
| (same tuna oil as used in example 1) | | | |
| Alkali metal salts of fatty acids | 0 | 0 | 0 |
| composition from tuna oil (as produced in | | | |
| Example 1) | | | |

All ingredients in weight % based on the total weight of the feed.

TABLE 9.2
FEED II (Experimental Diet)

| | Fry | Fingerling | Smolt |
|---|---|---|---|
| Animal Protein (fish meal, krill meal, | 62.5 | 55.1 | 45.4 |
| Poultry meal) | | | |
| Vegetal Protein (Soybean, Corn meal) | 0 | 15.0 | 22.0 |
| Hydrolysates | 11.0 | 0 | 3.0 |
| Vegetal Carbohydrates | 14.1 | 9.1 | 8.2 |
| Micronutrients (vitamins, minerals) | 2.0 | 2.0 | 2.0 |
| Tuna oil | 0 | 0 | 0 |
| (same tuna oil as used in example 1) | | | |
| Alkali metal salts of fatty acids | 10.4 | 18.8 | 19.4 |
| composition from tuna oil (as produced in | | | |
| Example 1) | | | |

All ingredients in weight % based on the total weight of the feed.

### 9. Shrimp Larvae Growth Test

A single spawn of Litopenaeus vannamei larvae was cultured until Mysis 2 in a 1.000 liter tank. The larvae hatched on day 1 and metamorphosed to Zoea 1 after 36 hours. Zoea 3 was reached on day 5 and Mysis 1 on day 8.

On day 10, the Mysis 2 were split into 5 tanks. The number of larvae was around 2.000 Mysis 2 per tank (1980, 1823, 1890, 1920, 1938 respectively).

The feeding schedule for Mysis 2 till PL is shown in table 9:

TABLE 9

| | FEED A | FEED B | FEED C | FEED D | FEED E |
|---|---|---|---|---|---|
| | (<50 micron) | (<50 micron) | (<50 micron) | (<50 micron) | (<50 micron) |
| 8:00 a.m. | 2 grams | 2 grams | 2 grams | 2 grams | 2 grams |
| 10:00 a.m. | F.A.N. | F.A.N. | F.A.N. | F.A.N. | F.A.N. |
| 1:00 p.m. | 2 grams | 2 grams | 2 grams | 2 grams | 2 grams |
| 3.30 pm | F.A.N. | F.A.N. | F.A.N. | F.A.N. | F.A.N. |
| 6:00 p.m. | 2 grams | 2 grams | 2 grams | 2 grams | 2 grams |
| 8:00 p.m. | F.A.N. | F.A.N. | F.A.N. | F.A.N. | F.A.N. |
| 11:00 p.m. | 2 grams | 2 grams | 2 grams | 2 grams | 2 grams |
| night | F.A.N. | F.A.N. | F.A.N. | F.A.N. | F.A.N. |

F.A.N.: Frozen Artemia Naupii

When reached Mysis 3, the feeds were changed to a size of 50-100 micron.

On day 12, the larvae started changing into Postlarvae (PL). The change developed as shown in table 10:

TABLE 10

| | FEED A | FEED B | FEED C | FEED D | FEED E |
|---|---|---|---|---|---|
| day 12 - 12 am | 10/40 = 25% | 13/30 = 43% | 17/29 = 58% | 14/32 = 44% | 16/30 = 40% |
| day 12 - 11 pm | 10/25 = 40% | 13/23 = 56% | 13/19 = 68% | 12/21 = 57% | 13/22 = 59% |
| day 13 - 09 am | 13/20 = 65% | 16/21 = 76% | 20/25 = 80% | 18/24 = 77% | 16/22 = 73% |

It can be observed that the Mysis that received the feeds comprising alkali metal salts of fatty acids moved faster to postlarvae than the group receiving feed formulated with Tuna Oil (Feed A).

The feeding schedule for postlarvae (until PL2, day 15) is shown in table 11:

TABLE 11

| | FEED A | FEED B | FEED C | FEED D | FEED E |
|---|---|---|---|---|---|
| | (50-100 | (50-100 | (50-100 | (50-100 | (50-100 |
| | micron) | micron) | micron) | micron) | micron) |
| 8:00 a.m. | 2 grams | 2 grams | 2 grams | 2 grams | 2 grams |
| 10:00 a.m. | F.A.N. | F.A.N. | F.A.N. | F.A.N. | F.A.N. |
| 1:00 p.m. | 2 grams | 2 grams | 2 grams | 2 grams | 2 grams |
| 3.30 pm | F.A.N. | F.A.N. | F.A.N. | F.A.N. | F.A.N. |
| 6:00 p.m. | 2 grams | 2 grams | 2 grams | 2 grams | 2 grams |
| 8:00 p.m. | F.A.N. | F.A.N. | F.A.N. | F.A.N. | F.A.N. |
| 11:00 p.m. | 2 grams | 2 grams | 2 grams | 2 grams | 2 grams |
| night | F.A.N. | F.A.N. | F.A.N. | F.A.N. | F.A.N. |

F.A.N.: Frozen Artemia Naupii

From PL3 onwards, the experimental feed changed to size of 100-200 micron. From PL5 onwards, the experimental feed changed to the size of 200-300 micron.

The feed was then distributed automatically with a belt feeder (7 times per day). At 10 am, 3 pm and 11 pm, the postlarvae received frozen copepods.

At PL15, all PL were counted, and some were measured. The PL lengths at PL 15 is shown in table 12:

TABLE 12

| | | | | Average | Estimated |
|---|---|---|---|---|---|
| | Total | smallest | largest | length | weight |
| | measured | (mm) | (mm) | (mm) | (mg) * |
| FEED A | 39 | 10 | 19 | 15.0 | 35.9 |
| FEED B | 36 | 11 | 23 | 17.7 | 56.5 |
| FEED C | 39 | 13 | 24 | 19.7 | 76.3 |
| FEED D | 37 | 11 | 23 | 17.8 | 57.6 |
| FEED E | 38 | 12 | 23 | 17.9 | 58.5 |

* The weight of the PL was estimated from the correlation published by Radulovich, R. and J. P. Fuentes-Quesada. 2019. Shrimp (Litopenaeus vannamei) artisanal production in floating cages at sea and polyculture with oyster (Crassostrea gigas). Aquaculture 512: 734354, FIG. 4.

At PL15, it is commonly accepted a size of 15 mm as very good, which was the result of Feed A, confirming that Feed A is an efficient state of the art standard formulation for shrimp larvae with fish oil (tuna oil). However, it can be observed that all the diets with alkali metal salts of fatty acids yielded longer PL, from 17 to 19 mm, which unveil the surprisingly superior bioavailability of fatty acid in the form of alkali metal salts of fatty acids composition instead of triglycerides, probably also as a higher digestible energy nutrient. Without wishing to be bound by theory, it is assumed that the surfactant properties of the alkali metal salts of fatty acids composition may improve the emulsification of the feeds in the shrimp gastrointestinal system, which could contribute to enhance the bioavailability of the nutrients. This aspect may also allow the reduction or elimination of the use of Lecithin in shrimp feed formulations by replacing with alkali metal salts of fatty acids.

As can be seen in the table above, the feeds where the oil (Tuna Oil in Feed A) were replaced with the alkali metal salts of fatty acids composition at the same percentage (6%), the increment in weight was more than 50%. And in the group with 9% of alkali metal salts of fatty acids (Feed C), the increment in weight was more than 100% compared to Feed A.

The total calculated biomass and relative FCR can be observed bellow:

TABLE 13

| | | Estimated | | |
|---|---|---|---|---|
| | | weight of a | | Relative Feed |
| | Total | single PL15 | Calculated | Conversion |
| | PL 15 | (mg) * | Biomass (g) | to Feed A |
| FEED A | 1011 | 35.9 | 36.3 | 1.000 |
| FEED B | 1082 | 56.5 | 61.1 | 0.594 |
| FEED C | 1186 | 76.3 | 90.5 | 0.401 |
| FEED D | 1113 | 57.6 | 64.1 | 0.566 |
| FEED E | 1143 | 58.5 | 66.9 | 0.543 |

During the trial all the groups received the same amount of feed, therefore we can calculate the relative FCR to group A as seen in the last column of table 13. The groups with the Feeds B, D & E, where the 6% of tuna oil of Feed A was replaced with 6% of alkali metal salts of fatty acids composition, yielded a FCR reduction from 41 to 46% relative to the control group A. And group C, where the 9% of tuna oil of Feed A was replaced with 9% of alkali metal salts of fatty acids composition, obtained an outstanding FCR reduction of 60% relative to Feed A.

The percentage of survival is shown in the table 14:

TABLE 14

| | Total Mysis 2 | Total PL15 | Survival % |
|---|---|---|---|
| FEED A | 1980 | 1011 | 51% |
| FEED B | 1823 | 1082 | 59% |
| FEED C | 1890 | 1186 | 62% |
| FEED D | 1920 | 1113 | 58% |
| FEED E | 1938 | 1143 | 59% |

As seen in table 14 all the feeds with alkali metal salts of fatty acids composition had a significant increase in survival rate compared to the standard feed A.

These unexpected results from feeding shrimp larvae with feeds comprising alkali metal salts of fatty acids may allow the reduction in use of Artemia Naupii.

### 10. Post Larvae Shrimp Growth Test

The three feeds of table 8 (Feed F, G & H) were tested with Post Larvae Shrimp (Litopenaeus vannamei) of 3 grams approximately at the time of starting.

Each diet was tested with 3 replicates, 9 baskets were utilized in total. Each basket received 12 shrimp. All baskets were placed in a bigger tank, so all baskets have the same water quality. Water quality in the big tank was maintained with bioflocs.

Each basket was equipped with an automatic feeder. The shrimp were fed continuously.

### Measurements During the Trial:

At start, after 2 weeks, after 4 weeks and 6 weeks, shrimp were counted and weighed together to have the total weight or biomass production.

Feed gift was adjusted daily according to an expected growth curve and average weight from initial and last measurement.

At the end of the growth trial, total weight, FCR and survival rate were calculated.

### Results Post Larvae Shrimp Growth Test (Table 15, 16, 17, 18 & 19):

TABLE 15

Number of shrimps

| | Start | Day 14 | Day 28 | Day 42 |
|---|---|---|---|---|
| FEED F | 36 | 30 | 26 | 22 |
| FEED G | 36 | 28 | 26 | 24 |
| FEED H | 36 | 28 | 24 | 23 |

TABLE 16

| | | Total Weight (Biomass), grams | | |
|---|---|---|---|---|
| | Start | Day 14 | Day 28 | Day 42 |
| FEED F | 124.54 | 160.75 | 211.73 | 225.71 |
| FEED G | 121.13 | 162.53 | 217.74 | 244.13 |
| FEED H | 128.82 | 155.30 | 194.58 | 241.23 |

TABLE 17

Results Post Larvae growth test

| | Number | Survival | Total weight | |
|---|---|---|---|---|
| | Shrimps | Rate, % | (Biomass), grams | FCR |
| FEED F | 22 | 61.1% | 225.71 | 1.362 |
| FEED G | 24 | 66.7% | 244.12 | 1.228 |
| FEED H | 23 | 63.9% | 241.23 | 1.257 |

As observed above, the two diets with a composition comprising alkali metal salts of fatty acids (FEED G and FEED H) resulted in a better survival rate than the standard feed containing no alkali metal salts of fatty acids (Feed F, with 2.5% of tuna oil).

The total weight or biomass production at the end of the trial was significantly higher for both diets with feeds comprising alkali metal salts of fatty acids, compared to the standard Feed F, and the Feed Conversion Rate of Feed G and Feed H was significantly lower than Feed F. The above results unveil the higher performance of the compositions comprising alkali metal salts of fatty acids over oils and fats (triglycerides) in conventional shrimp feed diets.

An unexpected result was observed: Feed H performed as well as Feed G. Both diets were made with feeds containing alkali metal salts of fatty acids, but Feed H utilized only alkali metal salts produced from vegetable oil (linseed oil) instead of alkali metal salts from fish oil (as Feed G), which provides a different profile of omega 3 fatty acids in the feed formulation. Table 18 below shows the content of the main Omega 3 fatty acids of the three feeds:

TABLE 18

| | % of main Omega 3 fatty acids in FEED F, G & H | | | |
|---|---|---|---|---|
| | ALA % | EPA % | DHA % | EPA + DHA |
| FEED F | <0.01% | 0.47% | 0.45% | 0.93% |
| FEED G | <0.01% | 0.45% | 0.44% | 0.89% |
| FEED H | 1.13% | 0.17% | 0.25% | 0.43% |

Feed H, compared to Feeds F & G, had less than 50% of the total concentration of EPA+DHA, two essential fatty acids in shrimp diets. However, the use of the composition from linseed oil in Feed H, which was rich in sodium salt of alpha linolenic acid (ALA), indicates that the use of marine oils could be reduced or suppressed when using alkaline metal salts of fatty acids of ALA (C18:3 n3). It seems that the alkali metal salt form of ALA has a superior bioavailability in shrimp diets, allowing EPA and DHA to be reduced in the feed formulation without a detrimental effect in the biomass production, survival and growth rate of the shrimps, on the contrary, and has the pivotal benefit of reducing the use of marine oils towards vegetable oil (as alkali metal salts of fatty acids).

Finally, the fatty acid profile was analyzed in samples of the lipid extract of shrimp tails. The lipid content was 0.54%, 0.61%, 0.59% for shrimps fed with FEED F, G & H respectively. The EPA & DHA content in the lipids are shown in table 19:

TABLE 19

| | % of main Omega 3 fatty acids in shrimp tail lipids | | |
|---|---|---|---|
| | ALA % | EPA % | DHA % |
| FEED F | 0.19% | 11.45% | 14.48% |
| FEED G | 0.24% | 12.41% | 16.72% |
| FEED H | 2.82% | 11.02% | 10.25% |

As observed in table 19, Feed G incorporated a higher concentration of EPA and DHA in the lipid present in the meat of the shrimp tail. The feeds of the present invention can thus incorporate in aquatic animal meat higher concentrations of omega 3 fatty acids than standard oils and fats contained in aquaculture feeds.

Again, the results of Feed H were unexpected. Feed H had the higher yield of inclusion of EPA and DHA in the shrimp tail meat.

### 11. Pre-Smolt Salmon Growth Test

Atlantic salmon fries (Salmo salar, n=3.600) with an initial average weight 2.3±0.2 g were randomly allocated to 12 experimental tanks (300 fries per tank, 6 tanks per group) containing river fresh water (100 L) and were followed for 240 days until smoltification. Water temperature, 13.1±1.7° C. and oxygenation (>85%) were maintained constant. Particulate feed, previously sieved and fractionated into 0.3-0.5 mm, 0.5-0.8 mm and 0.8-1.2 mm, was provided according to fish average weight of <0.8 g, <1.5 g and until smolts or <5 g, respectively. At the end of the trial all fish were counted. Table 20 below shows the effect on average fish weight increase with the experimental diet where tuna oil was replaced by the alkali metal salts of fatty acids composition from tuna oil.

TABLE 20

| | Average Pre Smolt Fish Weight | | |
|---|---|---|---|
| Testing time (days) | 95 | 120 | 240 |
| # of fish, FEED I | | | 1758 |
| # of fish, FEED II | | | 1784 |
| Control FEED I, g | 8.1 ± 1.4^{a} | 42.8 ± 3.6^{a} | 65.1 ± 2.3^{a} |
| Experimental FEED II, g | 8.9 ± 0.3^{b} | 44.6 ± 2.3^{b} | 69.1 ± 2.5^{b} |
| Total Biomass FEED I, kg | | | 114.45 |
| Total Biomass FEED II, kg | | | 123.27 |

As seen in table 20, salmon fed with FEED II comprising alkali metal salts of fatty acids yielded a higher biomass production compared to the group fed with FEED I which did not contain alkali metal salts of fatty acids, but fish oil (tuna oil).

### 12. Smolt Salmon Growth Test

Atlantic salmon smolt (Salmo salar, n=450) with an initial weight 51.3±6.8 g and total length 17.0±0.4 cm) (mean±SD) were randomly allocated to the experimental tanks (200 L and 1 m deep). Water temperature (7.8±0.1° C.), oxygenation (>85%) and 24 h photoperiod was maintained.

Fish were fed ad libitum for 3 month using automatic system twice per day, 30 min after uneaten feed and feces were removed, separated and frozen for further analysis. After anesthetized, fish were individually weighed, measured and fecal matter was obtained by stripping. The results are shown in table 21:

TABLE 21

| | Control diet | Experimental diet |
|---|---|---|
| | FEED I | FEED II |
| Number of Fish | 209 | 214 |
| Total Biomass, kg | 19.35 | 21.42 |

FEED II comprising the alkali metal salts of fatty acids yielded a higher biomass production efficiency compared to Feed I.

13. Post Larvae Shrimp Growth Test with Different Fatty Acid Derivatives.

A sample of the tuna oil utilized in example 1 was saponified and then neutralized: In a 2 liter Erlenmeyer, 250 grams of the tuna oil was contacted with a NaOH solution made with 200 grams of water, 200 grams of ethanol and 40 grams of NaOH. The mixture was refluxed for 2 hours with magnetic stirring to saponify the oil. The saponified mixture was cooled to 50° C. and then neutralized with 600 grams of an aqueous solution of citric acid at 40%. The neutralized mixture was transferred into a decantation funnel, and the aqueous phase was separated. The oily phase was washed two times with warm water and then dried in a rotavapor under vacuum to recover the free fatty acids from the tuna oil (FFA-TO).

The analysis of the free fatty acids recovered from the tuna oil is shown in table 22:

TABLE 22

| | Free Fatty Acids from |
|---|---|
| | Tuna Oil (FFA-TO) |
| Acid Value, mg KOH/g | 184.4 |
| Free Alkalinity, mg NaOH/g | n.d. |
| Total Alkalinity, mg NaOH/g | n.d. |
| TOTOX Value | 9.86 |
| Cholesterol, mg/g | 6.92 |
| Myristic acid, % | 6.47 |
| Palmitic acid, % | 19.19 |
| Palmitoleic acid, % | 8.56 |
| Stearic acid, % | 6.46 |
| Oleic acid, % | 20.18 |
| Linoleic acid, % | 3.26 |
| α-Linoleic acid, % | 0.80 |
| Stearidonic acid, % | 0.14 |
| Eicosenoic acid, % | 1.76 |
| Erucic acid, % | 1.42 |
| Arachidonic acid, % | 0.22 |
| Eicosapentaenoic acid, % | 7.54 |
| Docosapentaenoic acid, % | 0.13 |
| Docosahexaenoic acid, % | 13.55 |
| Total n3 PUFAs, % | 22.37 |

A new Feed (J) was formulated with the free fatty acids from tuna oil (FFA-TO) with the same procedure as in example 7.

TABLE 23

| | FEED J |
|---|---|
| Marine Protein | 26.0 |
| (fish meal, krill meal, squid meal) | |
| Vegetal Protein | 19.6 |
| (Canola meal, Wheat gluten, algae meal) | |
| Hydrolysates | 5.0 |
| Vegetal Carbohydrates | 42.4 |
| Micronutrients | 2.5 |
| (vitamins, minerals, cholesterol) | |
| Lecithin | 2.0 |
| Free Fatty Acids from Tuna oil | 2.5 |
| (same batch of tuna oil as used in example 1) | |

Feed J was tested in conjunction with a sample of Feed F & Feed G (from example 6) with Post Larvae Shrimp (Litopenaeus vannamei) of 3 grams approximately at the time of starting.

Each diet was tested with 3 replicates, 9 baskets were utilized in total. Each basket received 12 shrimp. All baskets were placed in a bigger tank, so all baskets have the same water quality. Water quality in the big tank was maintained with bioflocs.

Each basket was equipped with an automatic feeder. The shrimp were fed continuously.

### Measurements During the Trial:

At start, after 2 weeks, after 4 weeks and 6 weeks, shrimp were counted and weighed together to have the total weight or biomass production.

Feed gift was adjusted daily according to an expected growth curve and average weight from initial and last measurement.

At the end of the growth trial, total weight, FCR and survival rate were calculated.

### Results Post Larvae Shrimp Growth Test (Table 24, 25 & 26):

TABLE 24

Number of shrimp

| | Start | Day 14 | Day 28 | Day 42 |
|---|---|---|---|---|
| FEED F | 36 | 31 | 26 | 23 |
| FEED G | 36 | 30 | 27 | 24 |
| FEED J | 36 | 30 | 25 | 22 |

TABLE 25

| | | Total Weight, grams | | |
|---|---|---|---|---|
| | Start | Day 14 | Day 28 | Day 42 |
| FEED F | 125.46 | 161.73 | 210.54 | 229.71 |
| FEED G | 124.14 | 164.13 | 218.43 | 244.13 |
| FEED J | 125.31 | 158.40 | 203.58 | 226.53 |

TABLE 26

Results PL growth test

| | Number | Survival | Biomass, | |
|---|---|---|---|---|
| | Shrimps | Rate, % | grams | FCR |
| FEED F | 23 | 63.9% | 231.08 | 1.343 |
| FEED G | 24 | 66.7% | 253.22 | 1.203 |
| FEED J | 22 | 61.1% | 229.61 | 1.370 |

As observed in table 24, the diet with the feed comprising alkali metal salts of fatty acids (FEED G) resulted in a better survival rate than the two feeds without the alkali metal salts of fatty acids (Feed F, with 2.5% of tuna oil & Feed J, with 2.5% of free fatty acids).

The total weight or biomass production at the end of the trial was significantly higher in the diet with the feed comprising alkali metal salts of fatty acids a (Feed G), compared to the standard Feed F and Feed J with free fatty acids. Feed Conversion Rate of Feed G was significantly lower than the other two feeds. The above results show the higher performance of the alkali metal salts of fatty acids over oils and fats (triglycerides) and free fatty acids.

### 14. Smolt Salmon Pellet Tests

Three tests were performed to the pellets tested in the smolt growth test: Oil leakage, Sedimentation time and Flotation. Results are shown in table 27:
a. Oil leakage was measured as the loss of oil from 100 g of feeds incubated at 40° C. for 24 h in a heating cabinet. A 4-folded layer of blotting paper contained in a box was weighed at start (W1), after putting 100 g of granules or pellets in it (W2) and after removing all pellets and dust when incubation period was over (W3). Oil leakage was recorded on 6 replicate samples and its percentage was calculated as: [(W3−W1)/W2)·100]. Oil leakage was significantly decreased from FEED II compared to FEED I pellet diets.
b. Sedimentation time: For pellet feeds, the timing in which 40 pieces of diets sank by 1 meter in a tank filled with river fresh water was measured. The mean value was taken as the sedimentation time of the sample.
c. Flotation %: The number of 40 pieces of pellet that did not sink within 120 seconds in the sedimentation experiment above, was recorded.

TABLE 27

Pellet, size 1.2 mm

| | FEED I | FEED II |
|---|---|---|
| Oil leakage (%) | 6.2 | 1.8 |
| Sedimentation time (sec) | 180 | 184 |
| Flotation (%) | 94.9 | 96.0 |

As can be seen in above table, FEED II performed better than FEED I in the tests of Oil leakage, Sedimentation time and Flotation, which demonstrate the improved performance of pellets made of the alkali metal salts of fatty acids.

### 15. Oxidation Stability of Compositions Comprising Alkali Metal Salts of Fatty Acids

Six petri dishes, three with 10 grams each with a sample of the same tuna oil used in example 1 and three with 10 grams each with a sample of the alkali metal salts of fatty acids composition from tuna oil produced in example 1, were introduced in an oven at 40° C. After 48 hours, the samples were analyzed for Peroxide Value. Results are shown in table 28:

TABLE 28

Peroxide Value, meq/kg

| | | | after 48 h |
|---|---|---|---|
| Petri Dish | Product | initial | at 40° C. |
| 1 | Tuna Oil | 3.28 | 24.33 |
| 2 | Tuna Oil | 3.67 | 17.81 |
| 3 | Tuna Oil | 3.61 | 28.54 |
| Average | Tuna Oil | 3.52 | 23.56 |
| 4 | Alkali metal salts | 0.87 | 2.47 |
| | of fatty acids | | |
| 5 | Alkali metal salts | 0.75 | 4.21 |
| | of fatty acids | | |
| 6 | Alkali metal salts | 0.79 | 2.54 |
| | of fatty acids | | |
| Average | Alkali metal salts | 0.80 | 3.07 |
| | of fatty acids | | |

The alkali metal salts of fatty acids composition exhibits a significant superior oxidation stability towards the oil. This feature allows the extension of the shelf life of the formulations made with alkali metal salts of fatty acids compositions.

### 16. Pellet Stability Test

Six 100 ml Erlenmeyer flasks were charged with 75 ml of distillate water. Three of the Erlenmeyer were charged each with 2 grams of pellets of 1.5 mm from FEED A of example 5. The three remaining Erlenmeyer were charged each with 2 grams pellets of 1.5 mm of the FEED B of example 5.

The six Erlenmeyer were placed in an Erlenmeyer flask shaker at room temperature for 240 minutes at 200 U/min. After completing the shaking time, each Erlenmeyer content was filtrated, the remaining pellets washed with water and weighed. The recovered pellets were then analyzed for non-volatile matter in an oven at 105° C. for 24 hours. Results are shown in table 29:

TABLE 24

| | | Initial | | | Final | | | |
|---|---|---|---|---|---|---|---|---|
| | | Initial | | dry | Final wet | | dry | % |
| Flask | Pellet | weight, g | NV, % | content, g | weight, g | NV, % | content, g | Bleaching |
| 1 | FEED A | 2.034 | 91.45% | 1.860 | 1.904 | 75.21% | 1.432 | 23.02% |
| 2 | FEED A | 2.091 | 91.82% | 1.920 | 1.893 | 76.49% | 1.448 | 24.58% |
| 3 | FEED A | 2.128 | 92.04% | 1.959 | 1.912 | 75.73% | 1.448 | 26.07% |
| 4 | FEED B | 2.082 | 92.65% | 1.929 | 2.102 | 75.23% | 1.581 | 18.02% |
| 5 | FEED B | 2.107 | 92.14% | 1.941 | 2.065 | 75.92% | 1.568 | 19.25% |
| 6 | FEED B | 2.094 | 91.58% | 1.918 | 2.031 | 76.05% | 1.545 | 19.46% |

As observed above, the use of the alkali metal salts of fatty acids composition reduces bleaching of pellets. The use of alkali metal salts of fatty acids composition also improves the water stability of the feeds, reduces disintegration of the feeds and leaching of nutrients into water, acting as a binder aid.

In summary, the above examples disclose the improved advantages of the use of feeds containing one or more alkali metal salts of fatty acids:
Improved efficiency of production of small particle size feeds.
Improved bioavailability of fatty acids and nutrients, observed by improved biomass production and survival rate, resulting in increased biomass production efficiency.
Higher digestibility of feed, the alkali metal salts of fatty acids can act as emulsifier enhancer in the digestive system of aquatic animals.
Higher Stability and Shelf Life of fatty acids.
Higher Stability and Shelf Life of pellets.
Higher water stability, lower water pollution.
High energy pellets: alkali metal salts of fatty acids can be added in feed formulation at high levels, allowing a high energy pellet for maximum improvement of aquaculture performance.
Cost-effectiveness: feeds containing alkali metal salts of fatty acids are simple to produce and eliminates the extra process steps and cost of standard oil inclusion in pellets.
Improved use of natural resources: Previously discarded by-products obtained during oil processing can be processed to valuable products.
Improved PUFA production in the flesh of animals fed with the inventive feed.
Suitable matrix for additives such as minerals and vitamins, but also for pharmaceuticals.
Improved survival rate of aquacultured animals.
Improved biomass production efficiency in a hatcher or farm for aquatic animals such as fish and crustaceans.

1. A method for feeding a crustacean of the malacostraca class in a hatchery or farm of the crustacean, the method comprising feeding the crustacean with a feed comprising between 0.5 and 40% by weight of one or more alkali metal salts of fatty acids, relative to the total weight of the feed and wherein the feed increases a biomass and survival rate compared with a feed without alkali metal salts of fatty acids.

2. The method of claim 1, wherein the alkali metal of the alkali metal salts of fatty acids is selected from the group consisting of sodium, potassium and mixtures thereof.

3. The method of claim 1, wherein the crustacean is selected from the group consisting of Pacific White Shrimp, Black Tiger Shrimp, Indian White Shrimp, Kurume Shrimp, Northern White Shrimp, Banana Shrimp, Chinese White Shrimp, and Giant Tiger Prawn.

4. (canceled)

5. (canceled)

6. (canceled)

7. (canceled)

8. (canceled)

9. The method of claim 1, wherein the fatty acids of the alkali metal salts of fatty acids derive from vegetable oil, or mixtures of one or more vegetable oils and one or more marine oils or marine oil processed products comprising glycerides and fatty acid alkyl esters.

10. The method of claim 1, wherein the feeding is conducted continuously or intermittently between 2-12 times daily.

11. (canceled)

12. (canceled)

13. The method of claim 10, wherein the feed is in powder or pellet form.

14. (canceled)

15. The method of claim 9, wherein the feed comprises at least one fatty acid of the alkali metal salts of fatty acids is selected from the group consisting of palmitic acid, palmitoleic acid, stearic acid, oleic acid, linoleic acid, alpha linolenic acid, arachidonic acid, eicosapentaenoic acid and docosahexaenoic acid.

16. The method of claim 15, wherein the feed comprises one or more components selected from the group consisting of animal protein, plant protein, carbohydrates, vitamins, minerals, cholesterol and lecithin.

17. (canceled)

18. A method for feeding a crustacean of the malacostraca class in a hatchery or farm of the crustacean, the method comprising feeding the crustacean with a feed comprising one or more alkali metal salts of fatty acids, wherein the alkali metal consists of sodium, potassium and mixtures thereof, and comprises between 0.5 and 40% by weight of one or more alkali metal salts of fatty acids relative to the total weight of the feed and wherein the feed increases the biomass and survival rate compared with a feed without alkali metal salts of fatty acids.
